(19) United States
(12) Patent Application Publication
(10) Pub. No.: US 2025/0297624 A1
(43) Pub. Date: Sep. 25, 2025

(54) Automated Reasoning Methods and Systems for Diagnosing Equipment Faults as Constrained by Data and Physics

(71) Applicant: UCHICAGO ARGONNE, LLC, Chicago, IL (US)

(72) Inventors: Richard B. Vilim, Sugar Grove, IL (US); Tat Nghia Nguyen, Willowbrook, IL (US); Hubert Ley, Plainfield, IL (US)

(21) Appl. No.: 18/614,493

(22) Filed: Mar. 22, 2024

(51) Int. Cl. F15B 19/00

(52) U.S. Cl. CPC F15B 19/005; F15B 19/007

(57) ABSTRACT

Techniques disclosed herein for diagnosing faults include receiving a description of a sensor set. The techniques further include decomposing the sensor set, constructing a data-driven model for each sensor subset, and determining a fault association for each data-driven model residual. Using sensor measurements of a first sensor subset, the techniques further include calculating residuals of (i) the data-driven model and (ii) a physics-based model, determining a fault of a component or a sensor of the first sensor subset based on the residuals, and generating an alert indicating that the fault is present in the component or the sensor. These disclosed techniques advantageously integrate conventionally independent diagnostic techniques into a single diagnostic framework that outperforms such conventional configurations. Moreover, the disclosed techniques enable the integration of additional diagnostic techniques into well-established and/or otherwise currently implemented diagnostic approaches for a particular system, which was previously unachievable in conventional diagnostic systems.

### STATEMENT REGARDING FEDERALLY SPONSORED RESEARCH OR DEVELOPMENT

This invention was made with government support under Contract No. DE-AC02-06CH11357 awarded by the United States Department of Energy to UChicago Argonne, LLC, operator of Argonne National Laboratory. The government has certain rights in the invention.

### FIELD OF THE DISCLOSURE

The present disclosure relates to methods and systems for diagnosing faults, and specifically, to diagnosing faults in components of systems, as constrained by data-driven and physics-based modeling.

### BACKGROUND

Large, complex systems such as process control plants and power plants generally require constant monitoring and maintenance to prevent equipment degradation and accidents. Depending on the complexity of the systems involved, operations and maintenance (O&M) costs can be a significant challenge in various industries, including the nuclear energy industry. Computational diagnostic frameworks are generally utilized to monitor for and diagnose faults within these systems. However, improving computational diagnostic frameworks for detecting and diagnosing faults faces many technical challenges.

For example, conventional physics-based diagnostic frameworks are generally incapable of utilizing sensor measurements that are not inputs to equations representing the underlying physical performance of a system (e.g., conservation laws). These conventional physics-based diagnostic frameworks typically use physics-based models to analyze physical observables that can serve as inputs to the equations of the physics-based models, such as inflow/outflow temperature, pressure, etc. However, certain faults that occur within these systems are not accurately indicated by measurements of these physical observables, leading to uncertainty in the resulting diagnostic calculations. Thus, reliance solely on inputs to physics-based model equations frequently causes conventional physics-based models to output faults that are non-specific regarding the source of the fault.

On the other hand, conventional data-driven diagnostic frameworks treat systems as “black boxes” and construct system models purely based on data reconstruction techniques without any knowledge of the underlying physics of the system. These conventional data-driven diagnostic frameworks compute residuals between measured system values and predicted system values, and the residual values inform whether any faults are present within the system. However, without knowledge of the underlying system physics, these conventional data-driven diagnostic frameworks cannot provide cause-effect relationships between the residual values and possible faults of the system. Such conventional data-driven diagnostic frameworks rely on a separate diagnostic module that is trained for each specific system or application, which is time intensive, computationally intensive, and infeasible for many systems.

Accordingly, there is a need for improved computational diagnostic frameworks that address these technical challenges without sacrificing accuracy.

### SUMMARY OF THE DISCLOSURE

In some aspects, the techniques described herein relate to a method for diagnosing faults, the method including: receiving, at one or more processors, a description of a sensor set of a thermal hydraulic system, the description indicating, for each sensor of the sensor set, a sensor type and a location; decomposing, by the one or more processors, the sensor set into a plurality of sensor subsets, each sensor subset of the plurality of sensor subsets including sensors configured to monitor a physical process within the thermal hydraulic system that can be described using a physics-based model based on the sensor types and the locations; constructing, by the one or more processors, a data-driven model for each sensor subset of the plurality of sensor subsets; determining, by the one or more processors, a fault association for each residual of each data-driven model, the fault association corresponding to a sensor fault or a component fault within the thermal hydraulic system; receiving, by the one or more processors, sensor measurements captured by sensors of a first sensor subset of the plurality of sensor subsets at a time instance; calculating, by the one or more processors, residuals of (i) the data-driven model corresponding to the first sensor subset and (ii) a physics-based model corresponding to the first sensor subset; determining, by the one or more processors, a fault of a component or a sensor of the first sensor subset that is present at the time instance based on the residuals; and generating, by the one or more processors, an alert indicating that the fault is present in the component or the sensor.

In some aspects, the techniques described herein relate to a computer system for diagnosing faults, the computer system including: one or more processors; and a non-transitory computer-readable medium storing thereon instructions that, when executed by the one or more processors, cause the computer system to: receive a description of a sensor set of a thermal hydraulic system, the description indicating, for each sensor of the sensor set, a sensor type and a location, decompose the sensor set into a plurality of sensor subsets, each sensor subset of the plurality of sensor subsets including sensors configured to monitor a physical process within the thermal hydraulic system that can be described using a physics-based model based on the sensor types and the locations, construct a data-driven model for each sensor subset of the plurality of sensor subsets, determine a fault association for each residual of each data-driven model, the fault association corresponding to a sensor fault or a component fault within the thermal hydraulic system, receive sensor measurements captured by sensors of a first sensor subset of the plurality of sensor subsets at a time instance, calculate residuals of (i) the data-driven model corresponding to the first sensor subset and (ii) a physics-based model corresponding to the first sensor subset, determine a fault of a component or a sensor of the first sensor subset that is present at the time instance based on the residuals, and generate an alert indicating that the fault is present in the component or the sensor.

### BRIEF DESCRIPTION OF THE DRAWINGS

FIG. 1 is a block diagram of a system for diagnosing faults of a thermal hydraulic system.

FIG. 2 is an example logic workflow to integrate data-driven models and physics-based models for a system for improved fault diagnostics.

FIG. 3A is a schematic diagram illustrating an example high-pressure feedwater system with sensor locations.

FIG. 3B is a schematic diagram of a subsystem of the example high-pressure feedwater system from FIG. 3A.

FIG. 3C is an example data workflow including the data-driven model associated with the subsystem of FIG. 3B.

FIG. 4A is an example reactor feed pump configuration with several performance sensors and two other sensors measuring physical phenomena that are not used as inputs to a physics-based model.

FIG. 4B is an example graph illustrating a gross load of a generator over time, wherein the generator utilizes a reactor feed pump configured similarly to the example reactor feed pump of FIG. 4A.

FIG. 4C is an example graph illustrating vibration levels over time at inbound and outbound bearing locations for the pump of FIG. 4A.

FIG. 4D is an example graph illustrating temperature values over time for the inbound and outbound bearing locations of the pump of FIG. 4A.

FIG. 4E is an example diagnostics workflow to determine a fault of a component or a sensor based on sensor measurements and a combined diagnostic framework.

FIG. 5 is a flow diagram of an example method for diagnosing faults using a combined data-driven model and physics-based model approach.

### DETAILED DESCRIPTION

### Overview

The disclosed methods and systems describe techniques for diagnosing faults in systems, such as thermal hydraulic systems. More specifically, the disclosed techniques include a framework to integrate data-driven diagnostic methods/models (e.g., multivariate state estimation technique (MSET) models) into physics-based tools/systems (e.g., PRO-AID diagnostic tool) that utilize physics-based models. These disclosed techniques advantageously integrate conventionally independent diagnostic techniques (e.g., data-driven, physics-based) into a single diagnostic framework that outperforms such conventional configurations. Moreover, the disclosed techniques enable the integration of additional diagnostic techniques (e.g., data-driven approach) into well-established and/or otherwise currently implemented diagnostic approaches (e.g., physics-based approach) for a particular system, which was previously unachievable in conventional diagnostic systems. Descriptions of such physics-based tools and corresponding models may be found, for example, in U.S. Pat. Nos. 11,914,357 and 11,740,157, as well as U.S. patent application Ser. No. 17/136,673.

The disclosed techniques include constructing physics-based models and data-driven models for subsystems of a larger system. The data-driven models may be developed a priori using historical operating measurements that generally represent un-faulted operation of the subsystems and may include uncertainty represented by a shared statistical framework. The physics-based models can be in the form of parametric equations leveraging knowledge of the underlying physical phenomena of the subsystems and may be calibrated using historical sensor measurements of the system. Once constructed, the methods and systems of the present disclosure combine the data-driven diagnostic models with the physics-based diagnostic models to produce a single equipment health diagnosis.

For both models, residuals are formed/computed as differences between model predicted values of a process variable at a time instance and observed sensor measurements for that process variable at the time instance. Accordingly, the residuals are evaluated in real time as part of an automated reasoning process (e.g., diagnostics) to infer the origin and/or components involved in faults of the system/subsystems. Advantageously, the data-driven models, the physics-based models, and the corresponding residuals are formulated in a manner that enables simultaneous evaluation as part of the diagnostics process. A non-zero residual indicates a difference between a prediction and system behavior—i.e., a fault of a component or a sensor of the system/subsystem. Thus, the combined data-driven and physics-based fault diagnosis framework of the present disclosure can generate fault diagnoses of systems/subsystems by analyzing the non-zero residuals of the data-driven models and/or the physics-based models.

The systems and methods of this disclosure offer numerous benefits. While certain conventional diagnostic techniques utilize a purely physics-based diagnostic approach or a data-driven diagnostic approach, some conventional diagnostic techniques rely on an independently implemented combination of the two approaches. As a result, these conventional diagnostic techniques, at most, produce two independent diagnoses that do not inform or otherwise leverage insights from the other diagnostic technique. Thus, conventional diagnostic techniques are only capable of providing insights related to system faults at a granularity of the independent diagnoses, which is often non-specific and therefore non-optimal.

By contrast, the systems and methods of the present disclosure combine outputs of data-driven models with physics-based models to generate fault diagnoses with significantly greater specificity than conventional techniques. The physics-based models incorporate data of physical observables that directly correspond to the system performance, such that the residuals generated by the physics-based models accurately represent system faults leading to performance issues. The data-driven models can integrate sensor measurements (e.g., vibrations) that are not included as part of the first-principles (physics-based) approach and that capture physical phenomena of a system that are not related and/or indirectly related to the system performance. The data-driven models thereby produce residuals providing additional insights related to faults that are not accurately or clearly represented by the measurements included in the physics-based models. Accordingly, integrating the data-driven models with the physics-based models enables the techniques of the present disclosure to generate/determine system/component/sensor faults at a granularity that is superior to those of conventional techniques.

As part of this combined data-driven and physics-based approach, the techniques of the present disclosure determine fault associations between residuals output by the data-driven models and known component faults and/or sensor faults. With these fault associations and the underlying physical knowledge of the system from the physics-based models, the techniques of the present disclosure represent a combined diagnostic framework configured to identify a most likely fault based on the residuals from both models (i.e., data-driven and physics-based). In particular, the combined diagnostic framework includes logical rules to identify known component faults and/or sensor faults from both models, thereby creating a more robust ruleset than is leveraged in conventional techniques with independently implemented models. Thus, when the systems described herein receive real-time sensor measurements, the combined diagnostic framework determines a component fault and/or a sensor fault with a degree of specificity that was not previously achievable through such conventional techniques. Consequently, the combined fault diagnosis is more granular/specific than either independent fault diagnosis at least because the logical rules applied as part of the combined diagnostic framework are more expansive and thereby capture more of the inter-operational principles of the underlying system.

Additionally, the techniques of the present disclosure can determine fault diagnoses in real time based on live sensor measurements. Thus, the techniques of the present disclosure analyzing sensor measurements in real time and determining faults with such increased specificity over conventional systems, can save significant time and operating resources of system operators, technicians, engineers, and/or other entities associated with operation and maintenance of the corresponding system. For example, a system operator can use the techniques of this disclosure to monitor the health of a system as the system is operating. When the techniques of the present disclosure determine a fault, the system operator can quickly and easily identify the relevant component and initiate specific maintenance actions to resolve the fault based on the specific fault diagnosis provided by the techniques of the present disclosure. In short, these techniques can substantially reduce O&M system costs by pinpointing faults in both sensors and components as system equipment degrades over time.

It should be understood that while this disclosure primarily refers to diagnosing faults of a thermal hydraulic system, the techniques of this disclosure can apply to diagnosing faults in any system. In particular, the techniques of this disclosure can apply to any system which operates in accordance with physical conservation laws. For example, while this disclosure primarily refers to the example of a thermal hydraulic system, through which liquids in different phases flow, the techniques of this disclosure are also applicable to electrical systems, through which electrical currents flow, or to combined thermal hydraulic and electrical systems. Electrical components of a thermal hydraulic system, such as motors, can therefore also be analyzed using the techniques of this disclosure.

### Example Computing Environment

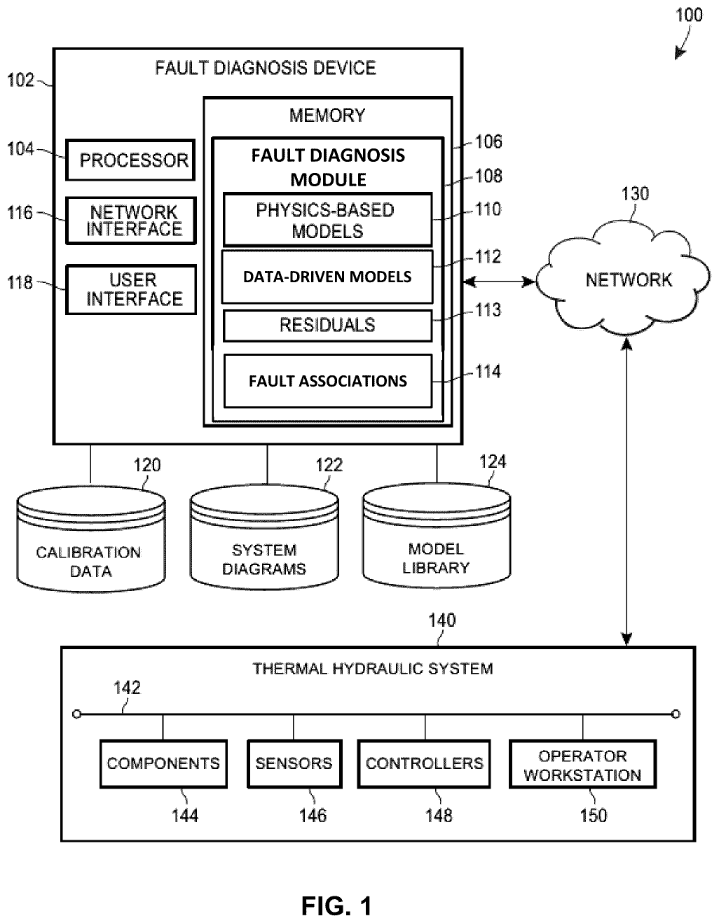

FIG. 1 is a block diagram of an example system 100 configured to implement the techniques of this disclosure for diagnosing faults of a thermal hydraulic system. It should be appreciated that the system 100 is merely an example and that alternative or additional components are envisioned. Further, as referenced herein, the term “fault” refers to any change in the characteristics of a component and/or a sensor that affects the ability of the component/sensor to perform its designed function. A fault causes an inconsistency between actual, observed behaviors of the component/sensor and behaviors predicted by a model. A particular component/sensor may be capable of experiencing multiple types of faults.

As an example, some models utilized in the present disclosure are physics-based models based on conservation equations (e.g., conservation of mass, energy, momentum). Any fault in the component/sensor results in an imbalance in these conservation equations, resulting in a difference between the prediction of the physics-based model and the observed value. Such a difference between a prediction of the physics-based model and an observed result is a “fault symptom” indicating a fault. Moreover, a “fault diagnosis” is a hypothesis that a set of one or more faults have occurred, and a “fault diagnosis framework” is a set of logical rules used to obtain all fault diagnoses whose sets of faults are consistent with the observed fault symptoms.

In any event, the system 100 may include a fault diagnosis device 102 configured to communicate with a thermal hydraulic system 140 via a network 130. The network 130 may include any suitable combination of wired and/or wireless communication network, and may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, cellular network, and others). While FIG. 1 depicts only one network 130, the fault diagnosis device 102 and the thermal hydraulic system 140 may additionally or alternatively communicate via a plurality of networks, depending on the implementation, and still fall within the scope of the present disclosure. For example, the network 130 may include any one or more of an Ethernet-based network, a private network, a cellular network, a local area network (LAN), and/or a wide area network (WAN), such as the Internet.

The fault diagnosis device 102 includes one or more processor(s) 104, which may be general purpose (e.g., CPUs) and/or special purpose processor(s), and a memory 106. The memory 106 may be a non-transitory memory and can include one or several memory modules, such as random access memory (RAM), read-only memory (ROM), flash memory, or other types of persistent memory, etc. The memory 106 can store computer-readable instructions executable on the processor 104. It will be understood that although the fault diagnosis device 102 is illustrated in FIG. 1 as a single device, in general the fault diagnosis device 102 can correspond to multiple computing devices.

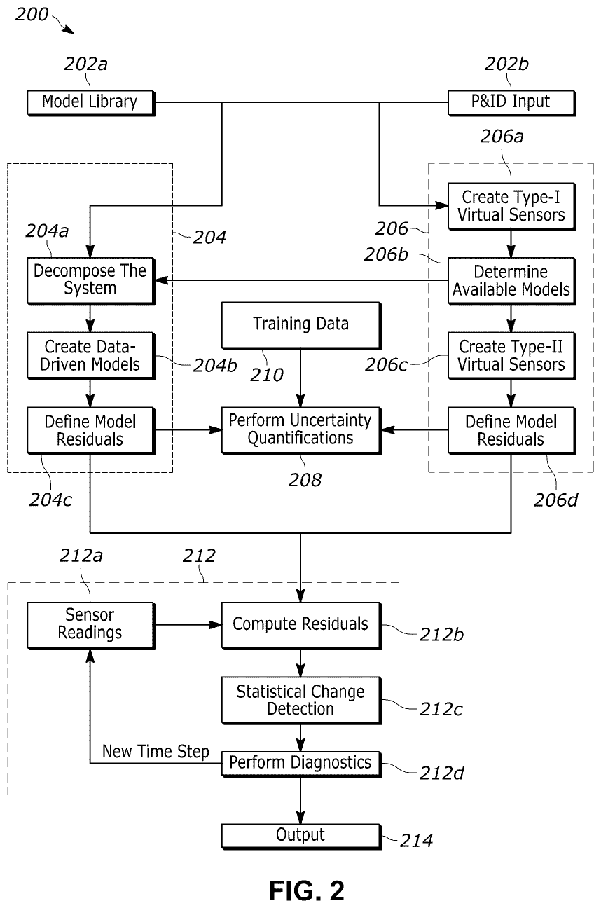

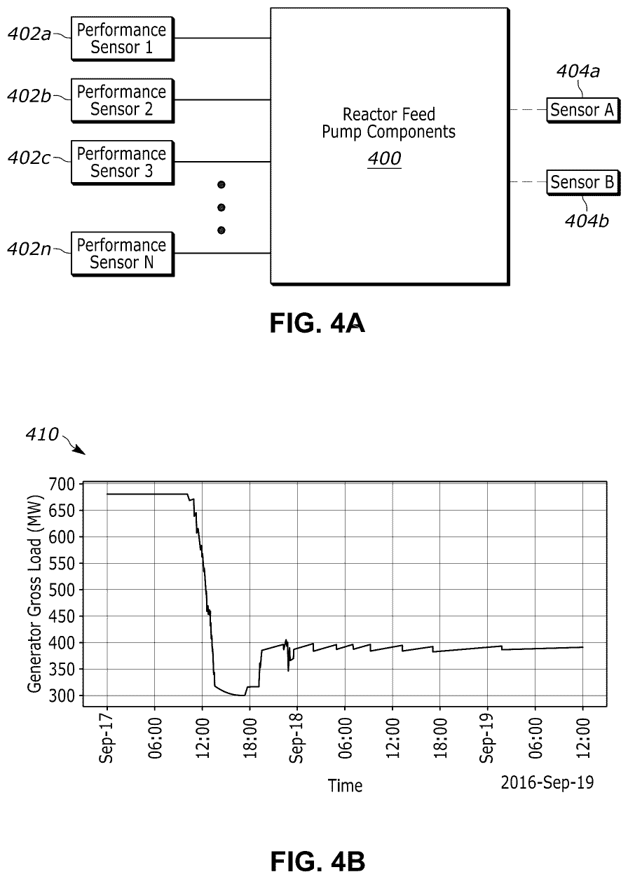

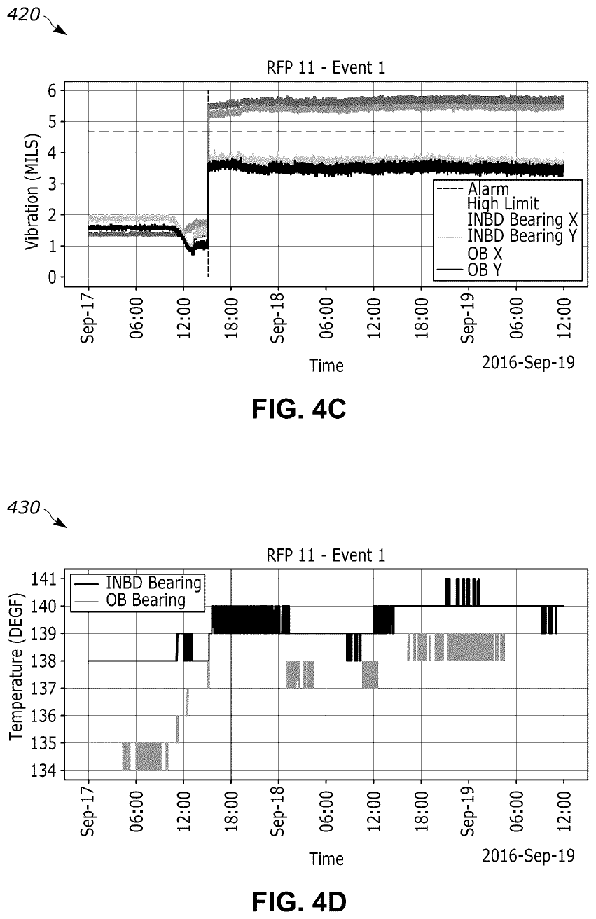

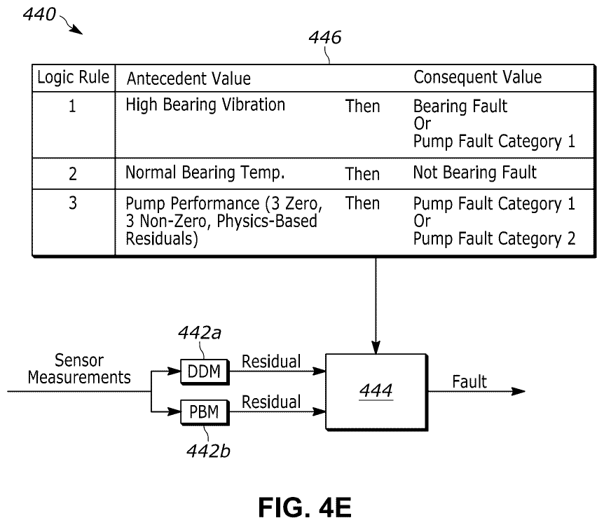

As illustrated in FIG. 1, the memory 106 stores a fault diagnosis module 108. Generally, using the fault diagnosis module 108, the fault diagnosis device 102 configures and applies a combined physics-based and data-driven diagnostic framework, as described herein. As part of this configuration and/or application, the fault diagnosis module 108 may be configured to generate physics-based models 110 and data-driven models 112, determine fault associations 114 for residuals 113 of the data-driven models 112, generate residuals 113 by applying the physics-based models and the data-driven models to data received from the thermal hydraulic system 140, and diagnose faults using the techniques discussed below with reference to FIGS. 2A-5. In particular, the fault diagnosis module 108 may generate physics-based models 110, data-driven models 112, and fault associations 114. The fault diagnosis module 108 may apply the physics-based models 110 and the data-driven models 112 to data from the thermal hydraulic system 140 to generate residuals 113, as will be described with reference to FIGS. 4A-4E. Further, while the fault diagnosis module 108 is described herein as performing many actions, it should be appreciated that the fault diagnosis module 108 may be or include executable instructions that cause the processors 104 of the fault diagnosis device 102 and/or processors of other suitable devices described herein to perform some/all of these actions.

Broadly, the fault diagnosis module 108 configures the combined physics-based and data-driven diagnostic framework described herein by performing two primary actions: (1) determining fault associations between the residuals of the data-driven models and possible faults (e.g., component faults, sensor faults), and (2) apply reasoning methods derived from the fault associations and underlying physics information of a system to perform fault diagnosis with the data-driven related fault symptoms and the physics-based related fault symptoms. This first action involves the fault diagnosis module 108 expanding a model library (e.g., model library 124) to include additional sensors associated with the data-driven model 112. The second action includes the fault diagnosis module 108 modifying the diagnostic framework configured for physics-based diagnostics to accommodate the data-driven fault symptoms.

Determining such fault associations between data-driven model residuals and possible faults involves the fault diagnosis module 108 performing several other preliminary actions. For example, the fault diagnosis module 108 decomposes a system of interest into separate components and/or subsystems based on the system description (e.g., P&ID). The fault diagnosis module 108 also determines the physics-based models that can be constructed for a specific component type within the system and the module 108 incorporates/stores the sensor set requirement for each model into the model library 124. The fault diagnosis module 108 then constructs physics-based models for each component or set of components, as allowed by the available sensor set. As described herein, a sensor set allows the fault diagnosis module 108 to construct a physics-based model for a particular component or set of components when the measurements collected by the sensor set allows the module 108 to evaluate first principles-based expressions (e.g., expressions including and/or derived from conservation laws).

Each physics-based model 110 provides predictions for a quantity (e.g., the overall heat transfer coefficient of a heat exchanger) that the fault diagnosis module 108 uses as a performance indicator for the underlying component. The fault diagnosis module 108 then generates residuals (e.g., residuals 113) based on analytical redundancy provided by the physics-based models 110. More specifically, the fault diagnosis module 108 generates residuals by computing differences between the physics-based model 110 measurement predictions and corresponding sensor measurements (e.g., real-time sensor measurements).

As discussed herein, deviations of a residual from an expected value (i.e., zero) represent an anomaly, also referenced as a “fault symptom”, which generally provides a basis for the fault diagnosis module 108 to detect and diagnose faults in the system. The fault diagnosis module 108 derives cause and effect relationships between component faults, sensor faults, and non-zero residuals directly from the physics-based analytical expression of the residuals. With any set of non-zero residuals and the corresponding cause and effect relationships, the fault diagnosis module 108 can utilize a deterministic reasoning approach and/or a probabilistic reasoning approach to determine fault diagnoses, such as whether the fault is associated with a component and/or a sensor and which particular component/sensor is a source of the fault.

By contrast, and as previously mentioned, the data-driven models 112 generally treat the modeled system (e.g., thermal hydraulic system 140) as a “black box”. As a result, the fault diagnosis module 108 constructs the data-driven models 112 based on data reconstruction techniques without any knowledge of the underlying physics of the modeled system. The fault diagnosis module 108 then applies the data-driven models 112 to provide predictions for individual sensor values (i.e., reconstructing the input sensor data). In certain embodiments, the data-driven models 112 utilize the MSET. However, it should be understood that the data-driven models 112 may utilize any suitable data reconstruction technique(s).

The fault diagnosis module 108 computes residuals for the data-driven models 112 based on a difference between the sensor measurements and a predicted value of each sensor. The fault diagnosis module 108 then detects faults based on significant changes in the residuals output by the data-driven models 112, which can include determining whether a residual is statistically non-zero. A residual is statistically non-zero (i.e., observed to be non-zero) when the mean value of the residual deviates from its normal value (i.e., changes from zero to non-zero). In certain embodiments, these significant changes include any statistically non-zero residuals output by the data-driven models 112. In other embodiments, the significant changes represent statistically significant deviations of the residuals output by the data-driven models 112 from zero, as determined based on a deviation threshold.

For example, the fault diagnosis module 108 may include a deviation threshold corresponding to the data-driven models 112 indicating that the mean value of residuals deviating from zero by more than a magnitude of 0.1 is statistically significant, and therefore likely indicates a fault within the system. In this example, the fault diagnosis module 108 may determine that a mean value of a residual of 0.01 corresponding with a first sensor is a non-zero residual that does not exceed the deviation threshold, and therefore does not likely indicate a fault within the system. The fault diagnosis module 108 may also determine that a mean value of a residual of 0.2 corresponding with a second sensor is a non-zero residual that exceeds the deviation threshold, and therefore likely indicates a fault within the system (e.g., likely corresponding to the second sensor and/or component(s) associated with the second sensor).

As indicated by the purely mathematical analysis of the data-driven model 112 residuals, the data-driven models 112 provide no cause-effect knowledge/relationships between of possible faults of a system and residuals associated with the system components/sensors. To overcome this lack of cause-effect relationships, conventional techniques typically incorporate separate diagnostic modules developed for each specific system and/or subsystem. These conventional diagnostic modules must rely on some prior knowledge of the specific system (e.g., known fault signatures), such that deducing fault diagnoses based on an observed set of non-zero residuals must necessarily be performed by module(s) developed for each specific system/subsystem. However, as mentioned, developing and incorporating these conventional diagnostic modules is a laborious, intensely resource-consuming process that ultimately fails to achieve the fault specificity of the techniques described herein.

Accordingly, to overcome these issues experienced by conventional techniques and achieve superior fault specificity, the fault diagnosis module 108 analyzes the data-driven model 112 residuals and the physics-based model 110 residuals in combination, in accordance with a combined physics-based and data-driven diagnostic framework to perform fault diagnosis. This combined physics-based and data-driven diagnostic framework also incorporates other physics-based knowledge of the system (e.g., the system P&ID) to inform the fault diagnosis. In this manner, the fault diagnosis module 108 uses the data-driven model 112 residuals as additional fault symptoms for the combined reasoning process. The fault diagnosis module 108 also utilizes physics-based knowledge from the physics-based models 110, P&ID, and/or other sources to provide the necessary physics-based knowledge for determining fault associations between data-driven model 112 residuals and system 140 components/sensors.

With continued reference to FIG. 1, and in some embodiments, the fault diagnosis module 108 is stored as computer-readable instructions executable on the processor 104. It should also be noted that although FIG. 1 illustrates the module 108 as stored on the memory 106, the module 108 can also be provided in the form of online services accessible via a web browser executing on the fault diagnosis device 102, as plug-ins or extensions for another software application executing on the fault diagnosis device 102, as instructions on a cloud-based memory, etc.

Further, in some embodiments, functionalities of the fault diagnosis module 108 are performed by different computing devices and/or different applications. As one example, a first computing device may construct the physics-based models 110 and data-driven models 112, generate the fault associations 114, and provide the physics-based models 110, data-driven models 112, and the fault associations 114 to a second computing device (e.g., as computer-readable instructions), which in turn generates the residuals 113 using data from the thermal hydraulic system 140 and diagnoses faults of the thermal hydraulic system 140.

In addition, the fault diagnosis device 102 includes a network interface 116 configured to communicate data with other computing devices and systems, such as the thermal hydraulic system 140, via the network 130. The network interface 116 may include one or more transceivers (e.g., WWAN, WLAN, and/or WPAN transceivers) functioning in accordance with IEEE standards, 3GPP standards, or other communication standards, and configured to receive and transmit data via one or more external ports.

The fault diagnosis device 102 also includes a user interface 118. The user interface 118 includes hardware, firmware, and/or software configured to enable a user to interact with (i.e., both provide inputs to and perceive outputs of) the fault diagnosis device 102. For example, the user interface 118 may include a touchscreen with both display (e.g., video display device) and manual input capabilities. Alternatively, or in addition, the user interface 118 may include a keyboard for accepting user inputs, and/or a microphone (with associated processing components) that provides voice control/input capabilities to the user. As another example, the user interface 118 may include speakers capable of emitting audio. The user interface 118 may include a combination of peripheral devices (e.g., a keyboard and mouse) and one or more display screens. A user may interact with the user interface 118 to configure the fault diagnosis module 108, view and/or adjust the physics-based models 110 and/or the data-driven models 112, view and/or adjust the fault associations 114, view the residuals 113, view fault diagnoses, etc. For example, the fault diagnosis module 108 may implement graphical user interfaces that the fault diagnosis device 102 can display and a user can interact with via the user interface 118.

The fault diagnosis device 102 may be communicatively connected to databases such as a calibration database 120, a system diagrams database 122, and a model library 124. The calibration database 120 may be populated with historical data gathered by the thermal hydraulic system 140. As discussed below, the fault diagnosis device 102 can use historical data stored in the calibration database 120 to calibrate the physics-based models 110. The system diagrams database 122 may include diagrams, schematic representations, or textual descriptions of systems. For example, the system diagrams database 122 may store piping and instrumentation diagrams (P&IDs) of systems. A P&ID of a system represents the system as an interconnected collection of components and identifies the locations of sensors. The model library 124 includes descriptions of previously-constructed physics based models and/or data-driven models, including, for example, the type of component to which the model applies and the sensors required to calibrate the model. The fault diagnosis device 102 may store the physics-based models 110 and/or the data-driven models 112 that the fault diagnosis device 102 constructs in the model library 124, and may retrieve models from the model library 124. The databases 120, 122, and 124 may use any known database architecture. Further, one or more or the databases 120, 122, and 124 may be implemented using cloud technology and may reside on a distributed network of computing devices rather than a single computing device. In some embodiments, the fault diagnosis device 102 may store all or portions of the databases 120, 122, and/or 124 in the memory 106.

The fault diagnosis device 102 is communicatively coupled via the network 130 to a system in which faults are to be diagnosed, such as the thermal hydraulic system 140. The thermal hydraulic system 140 may be, for example, a process control plant, a nuclear power plant, a nuclear reactor, a nuclear engineering system, a steam power plant, a thermal power plant or other type of power plant, chemical plant, or the like, or a system within these systems. As described above, the system in which faults are to be diagnosed need not be a thermal hydraulic system, per se, but may be any whole or partial system or process plant that can be modeled using first-principles (i.e., physics-based) models.

The various parts of the thermal hydraulic system 140 may be communicatively connected via wired or wireless connections to a data bus 142. The data bus 142 may in turn by communicatively connected to the fault diagnosis device 102 via the network 130. The thermal hydraulic system 140 includes components 144 (e.g., pumps, valves, heat exchangers, heaters, condensers, pipes, junctions, motors, etc.) and sensors 146. In some embodiments, the components 144 may include only a single component (or only a single component of the components 144 may be analyzed). The sensors 146 may monitor conditions of the thermal hydraulic system 140 as a whole or may monitor parameters of the components 144 (e.g., flow rate, temperature, pressure, etc.). The sensors 146 may be affixed onto the components 144 or be installed within or be part of the components 144.

The thermal hydraulic system 140 also includes one or more controllers 148 including control circuitry for controlling the components 144 and the sensors 146. For example, the controllers 148 may control the activation and/or deactivation and modify settings of the components 144 and the sensors 146. Further, the controllers 148 may modify notification settings of the sensors 146 (e.g., what information the sensors 146 provide to the data bus 142 and at what times). The controllers 148 may transmit data and instructions to the components 144 and the sensors 146 via the data bus 142, and may receive information (e.g., responses to the instructions, measurements from the sensors 146) from the components 144 and the sensors 146 via the data bus 142. The controllers 148 also may provide data (e.g., data exchanged with parts of the thermal hydraulic system 140) to the data bus 142. This data may include indications of parts of the thermal hydraulic system 140 that are activated or deactivated (e.g., including timestamps), as well as indications of controlled settings and indications of instances in which controlled settings are modified (e.g., including timestamps).

A user, such as a plant operator, may issue instructions to the controllers 148 and monitor information received from the data bus 142 (e.g., from the controllers 148, components 144, or the sensors 146) via an operator workstation 150. The operator workstation 150 may be a personal computer, a laptop, a smartphone, a tablet, a wearable portable device, etc. Generally, the operator workstation 150 may include a processor, a memory, a network interface, and a user interface (e.g., including a display and user inputs), similar to the fault diagnosis device 102. The thermal hydraulic system 140 may include multiple operator workstations 150 and/or multiple controllers 148. For example, each system component of the components 144 may be associated with a different controller or controllers. Each controller may be associated with one operator workstation, or an operator workstation can be used to configure multiple controllers. The fault diagnosis device 102 can transmit fault diagnoses or other output data to the operator workstation, which can display, present, or process the fault diagnoses and/or output data. Likewise, the operator workstation 150 can manage transmission of input data from the thermal hydraulic system 140 to the fault diagnosis device 102.

The fault diagnosis device 102 may generate alerts including output data such as a diagnosed fault. The fault diagnosis device 102 may itself present generated alerts to a user of fault diagnosis device 102. For example, the alert may be a notification that can be displayed by a display of the user interface 118 and/or an audio notification that can be emitted by a speaker of the user interface 118. Alternatively, or in addition, the fault diagnosis device 102 can transmit the alert to the operator workstation 150, the controllers 148, or another computing device of the thermal hydraulic system 140. The operator workstation 150 can then display or otherwise present the alert to a user or transmit an indication of the alert to the controllers 148. For example, the operator workstation 150 (or the fault diagnosis device 102) can generate a remedial action (e.g., turn off a faulty component or sensor, redirect flow away from a faulty component or sensor) based on a fault diagnosis, and transmit control instructions to one of the controllers 148 to cause the thermal hydraulic system 140 to perform the remedial action.

To illustrate the overall integration scheme of the techniques described herein, FIG. 2 illustrates an example logic workflow 200 to integrate data-driven models and physics-based models for a system for improved fault diagnostics. The example logic workflow 200 broadly includes a construction phase and a real-time reasoning phase. The construction phase includes each of blocks 202a, 202b, 204, 206, 208, and 210. The real-time reasoning phase includes blocks 212 and 214.

The construction phase begins by receiving inputs from the model library 202a and a P&ID input 202b. As discussed herein, the model library 202a includes descriptions of models (e.g., physics-based models, data-driven models) configured to model the behavior of components/sensors included as part of the system, as well as descriptions of the corresponding models and sensors. The P&ID input 202b generally represents the system as an interconnected collection of components and identifies the locations of sensors.

Both the data-driven modeling flow 204 and the physics-based modeling flow 206 utilize data from the model library 202a and the P&ID input 202b to perform subsequent actions. The data-driven modeling flow 204 and the physics-based modeling flow 206 both correspond to sets of actions/steps configured to construct data-driven and physics-based models and define/determine the model residuals. Thus, after the sets of actions in both the data-driven modeling flow 204 and the physics-based modeling flow 206 are completed, the real-time reasoning phase can diagnose faults of a system using the combined data-driven and physics-based approach described herein.

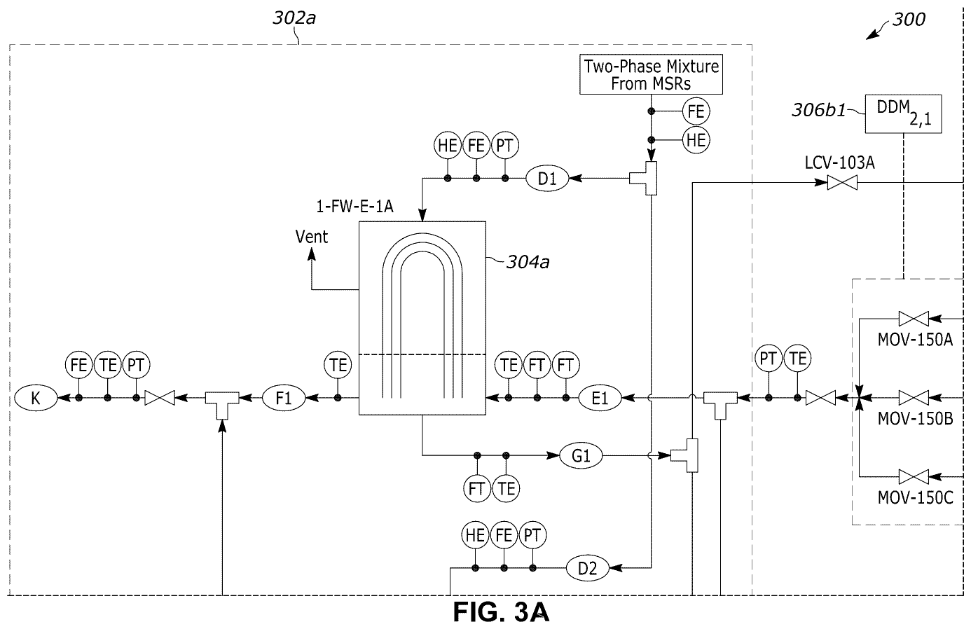

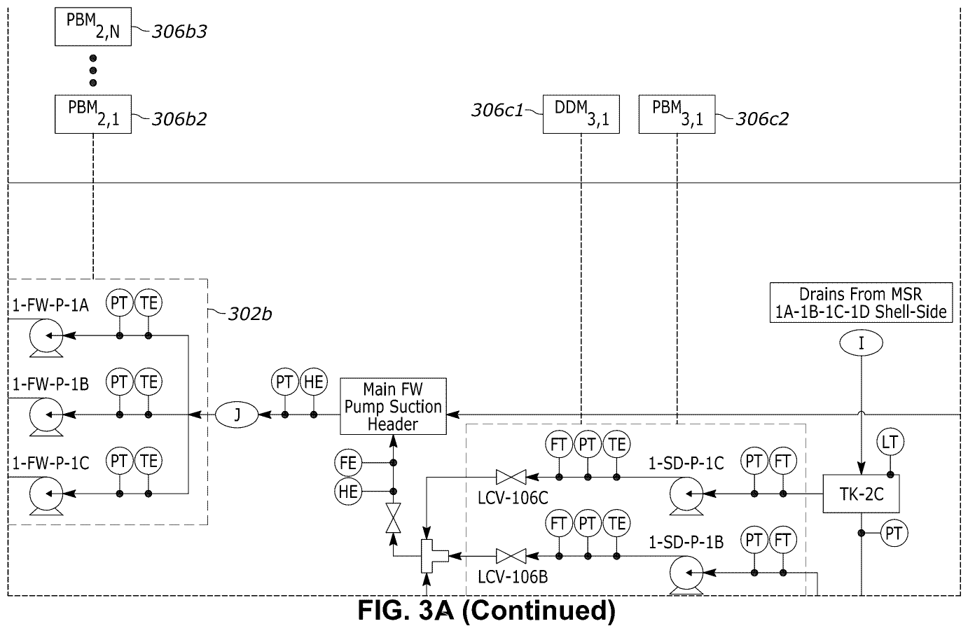

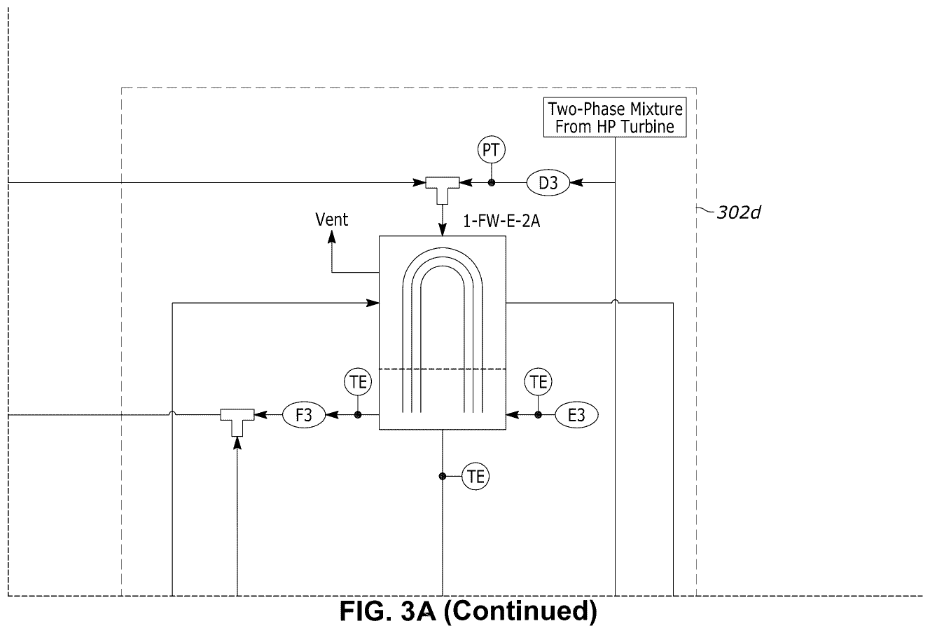

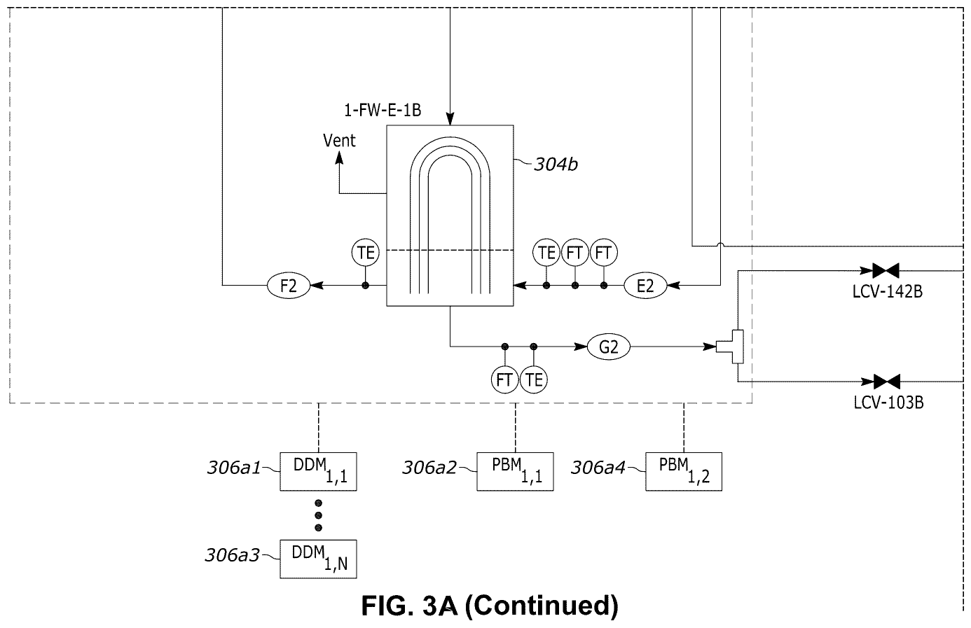

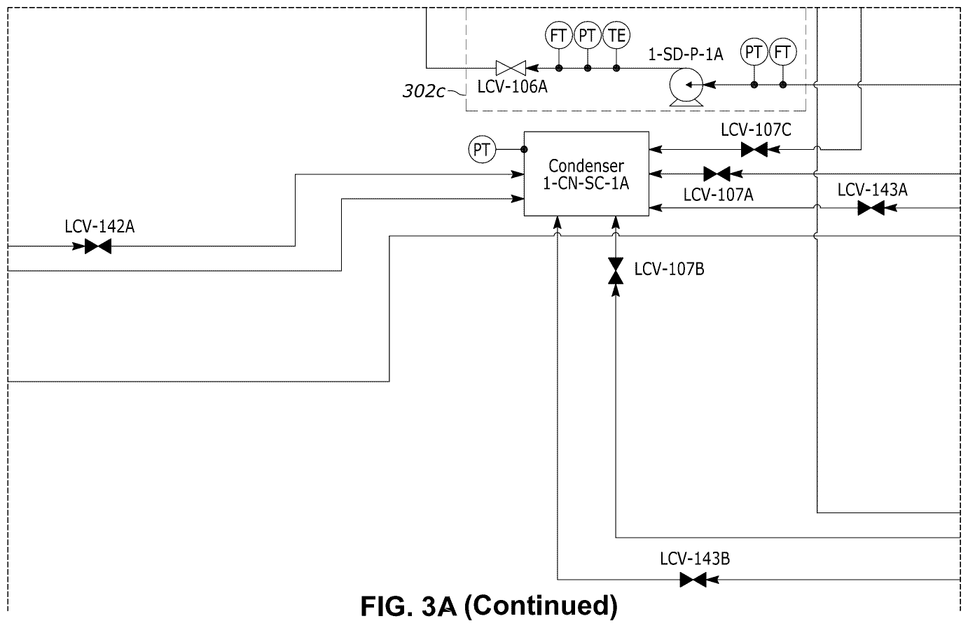

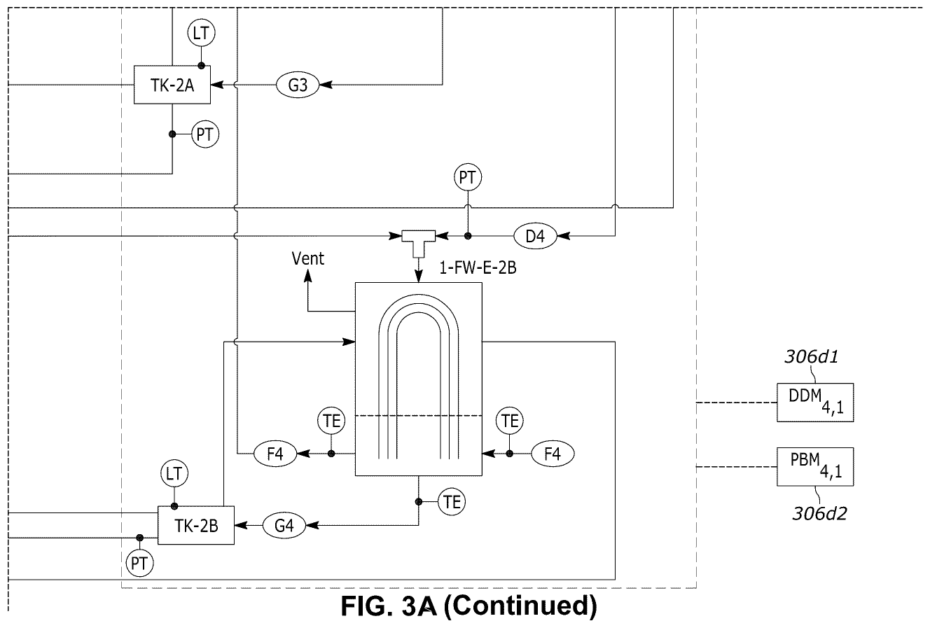

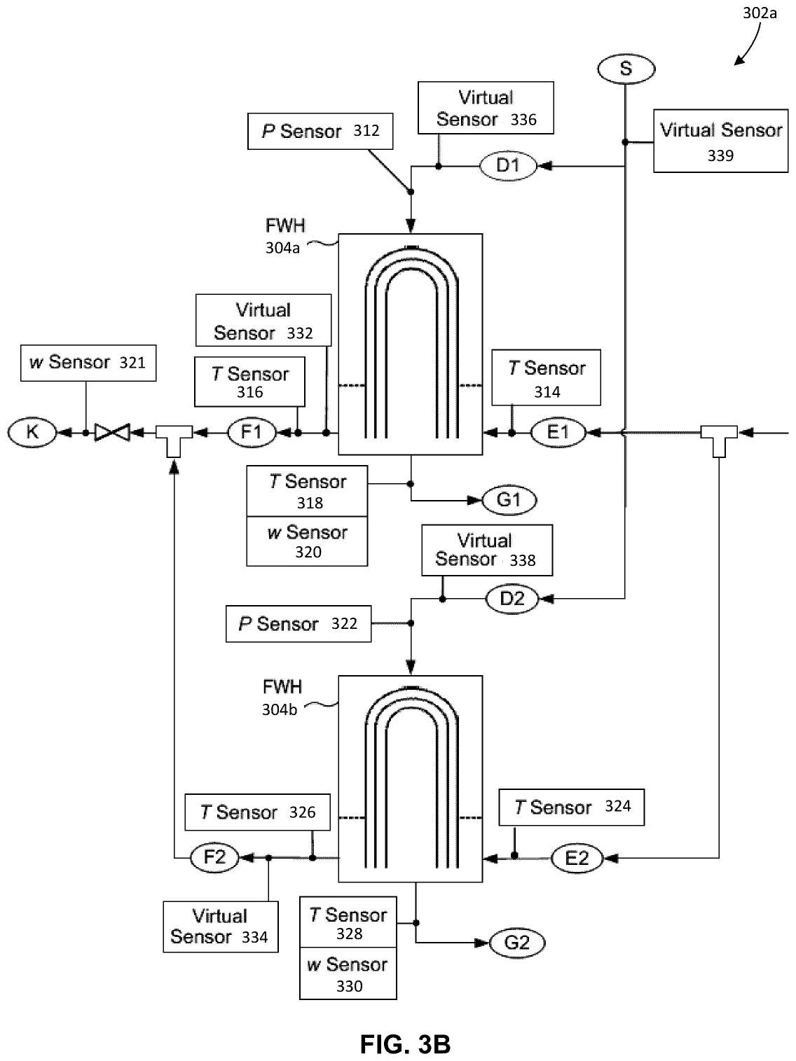

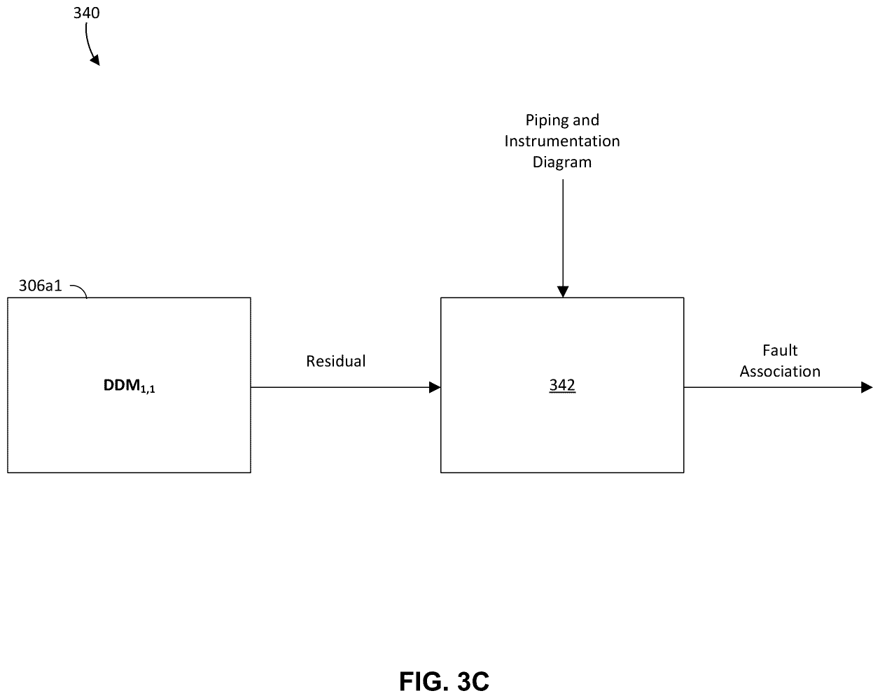

The data-driven modeling flow 204 includes decomposing an available system (e.g., sensor set) (block 204a), creating the data-driven models (block 204b), and defining the model residuals (block 204c). At block 204a, a fault diagnosis component (e.g., fault diagnosis module 108) decomposes the available sensor set based on, for example, the physics-based component models that can be constructed for a particular set of sensors that are included in the available sensor set. The physics-based component models that can be constructed for a particular set of sensors are determined at block 206b, and these available models subsequently inform the sensor set/system decomposition performed at block 204a. Using the decomposed sensor set, at block 204b, the fault diagnosis module 108 can create data-driven model(s) for each decomposed sensor set. Further, at block 204c, when the fault diagnosis module 108 creates the data-driven models, the module 108 can define/determine residuals for each data-driven model. In certain embodiments, determining the residuals for each data-driven model includes determining fault associations for each residual, where each fault association corresponds to a sensor fault or a component fault within the system. An example system/sensor set decomposition, model creation, and residual definition/determination is further discussed in reference to FIGS. 3A-3C.

The physics-based modeling flow 206 includes creating type-I virtual sensors (block 206a), determining available physics-based models (block 206b), creating type-II virtual sensors (block 206c), and defining the model residuals (block 206d). Generally, the term “virtual sensor” is a convenient shorthand to refer to an expression for a variable that is not directly measured but can be estimated using other sensors of the system. The type-I virtual sensors may generally be model-free virtual sensors created to enable application of certain physics-based models. The type-II virtual sensors may generally be model-enabled virtual sensors created to increase a number of independent model residuals that can be generated, and thereby improve the diagnostic resolution of the real-time reasoning phase.

In certain embodiments, type-I virtual sensors include virtual sensors obtained from solving equations (e.g., loop balance equations) describing a system/subsystem, and such virtual sensors can be used to generate residual expressions associated with the system. In some embodiments, type-II virtual sensors are created and used by the fault diagnosis module 108 to generate additional residual expressions corresponding to the system.

At block 206a, a fault diagnosis component (e.g., fault diagnosis module 108) creates type-I virtual sensors based on components and/or subsystems that require such virtual sensors to have sufficient observable quantities to evaluate at least one first-principles equation (e.g., conservation laws). Accordingly, the fault diagnosis module 108 proceeds to determine the available physics-based models for each component/sensor set, etc. (block 206b). To increase the number of total model residuals, the fault diagnosis module 108 may then create type-II virtual sensors (block 206c). At block 206d, the fault diagnosis module 108 defines/determines the model residuals for the physics-based models based on the available physics-based models for each component/sensor set and the type-II virtual sensors.

When the fault diagnosis module 108 determines model residuals for both the data-driven models (block 204c) and the physics-based models (block 206d), the module 108 may perform uncertainty quantifications 208. Namely, the fault diagnosis module 108 utilizes training data 210 in combination with the created/available models and determined residuals to determine uncertainties associated with the residuals output by the data-driven models and the physics-based models. When the uncertainties associated with the data-driven models and the physics-based models satisfy uncertainty thresholds, the fault diagnosis module 108 applies the models to real-time sensor measurements in the real-time reasoning phase.

The real-time reasoning phase broadly includes the reasoning flow 212 that results in an output 214. The reasoning flow 212 includes receiving sensor measurements 212a at a time instance, to which the fault diagnosis module 108 applies the data-driven models and the physics-based models to compute residuals (block 212b). The fault diagnosis module 108 also performs statistical change detection (block 212c) on these residuals to determine whether any/which of the residuals deviates from the sensor measurements 212a in a statistically significant manner (i.e., is a non-zero residual). In certain embodiments, this statistical change detection includes the fault diagnosis module 108 estimating a standard deviation and a mean of a particular residual using historical measurements. The fault diagnosis module 108 then determines that the particular residual is statistically non-zero if, for the particular residual at the time instance, a decision function of a statistical change algorithm exceeds a threshold.

In response to determining that one or more residuals are non-zero, the fault diagnosis module 108 performs diagnostics (block 212d), in accordance with the combined physics-based and data-driven diagnostic framework described herein, to determine an output 214. The output 214 is or includes a fault diagnosis indicating a fault of a component or a sensor that is present in the component or the sensor at the time instance consistent with the sensor measurements 212a. In certain embodiments, the fault diagnosis module 108 performs the diagnostics at block 212d to generate the output 214 by determining a first fault set including one or more faults indicated by one or more residuals of the data-driven model and determining a second fault set including one or more faults indicated by one or more residuals of the physics-based model. Based on these fault sets, the fault diagnosis module 108 determines the fault of the component or the sensor by identifying the fault is consistent with the first fault set and the second fault set.

In certain embodiments, the output 214 also is and/or includes an alert indicating that the fault is present in the component or sensor and/or a probability of the fault, and the alert is configured for display to a user/operator. In some embodiments, the fault diagnosis module 108 also determines an action sufficient to address the fault and transmits a control instruction to a controller of the system to perform the action. For example, the fault diagnosis module 108 may determine a fault indicating that a pump has failed and may also determine that turning the pump off would address the fault. Accordingly, in this example, the fault diagnosis module 108 may transmit a control instruction to a controller (e.g., of controllers 148) associated with the pump to cause the controller to turn the pump off.

Moreover, in response to determining that no residuals are non-zero, the fault diagnosis module 108 can generate an output 214 indicating that no faults are detected at the time instance based on the sensor measurements 212a. Accordingly, the fault diagnosis module 108 returns to block 212a at a subsequent time instance to receive new sensor measurements and repeat the analysis of the reasoning flow 212 with the new sensor measurements.

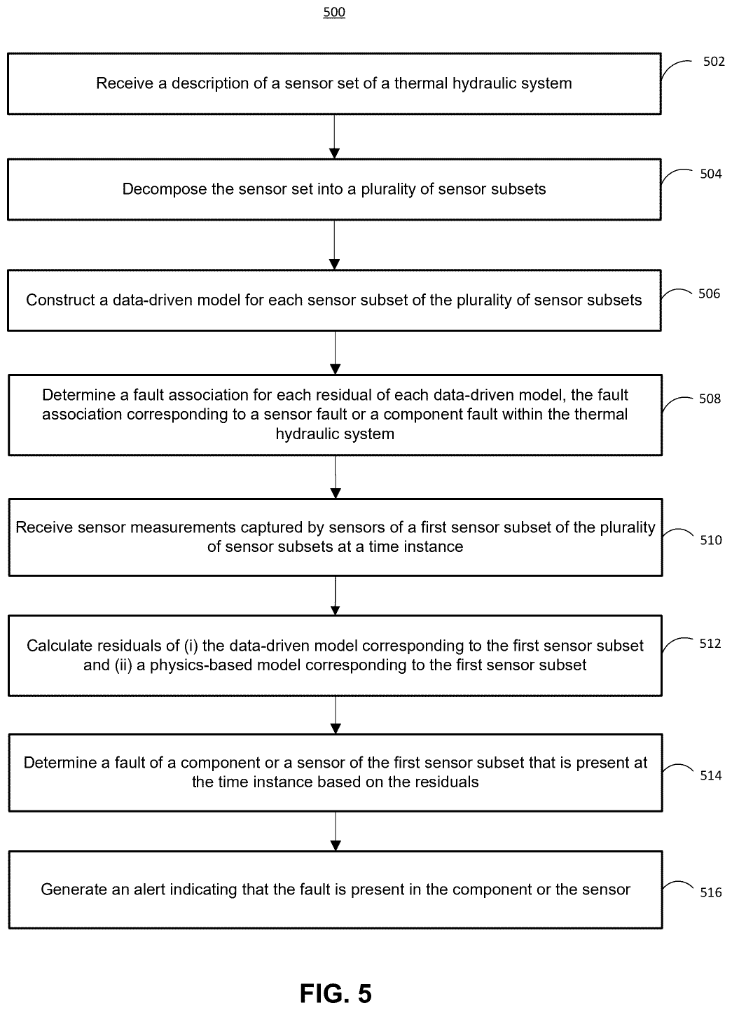

As mentioned, the techniques of the present disclosure involve generating and applying a combined physics-based and data-driven diagnostic framework to diagnose faults of components/sensors of systems with higher specificity than was previously achievable using conventional techniques. To provide a better understanding of these actions performed in reference to FIGS. 1 and 2 as part of the present techniques that achieve these advantages, FIGS. 3A and 3B illustrate example schematic diagrams of example systems that are decomposed into smaller subsystems based on available sensors, and FIG. 3C illustrates an example workflow for determining fault associations of data-driven models associated with these smaller subsystems. Moreover, FIGS. 4A-4E illustrate an example implementation of such a combined diagnostic framework to determine faults and/or generate alerts, and FIG. 5 illustrates an example method of this disclosure.

Example Decomposition of Systems with Sensor Sets

As discussed in reference to FIG. 1, the fault diagnosis module 108 configures the combined physics-based and data-driven diagnostic framework described herein, in part, by determining fault associations between the residuals of the data-driven models and possible faults. For a system (e.g., thermal hydraulic system 140) with a given sensor set (e.g., sensor 146), the data-driven models 112 generate a residual for each sensor. The fault diagnosis module 108 utilizes the physics-based knowledge from the physics-based models 110 and other system information (e.g., P&ID stored in the system diagrams 122) to determine the fault associations (i.e., cause and effect relationships) between each data-driven model 112 residual and possible component faults and sensor faults in the system 140.

Broadly, this determination performed by the fault diagnosis module 108 is a two-step process. First, the fault diagnosis module 108 incorporates effects of possible faults in a component (e.g., components 144) on the component's process variables into the physics knowledge base of the system (e.g., as stored in memory 106 and/or any of the connected devices 120, 122, 124). One or more sensors (e.g., sensors 146) local to the component can measure these process variables. Thus, by incorporating these effects, the fault diagnosis module 108 incorporates information that supports additional data-driven sensors and residuals known through fault associations that are not modeled analytically using first-principles physics. The second step in determining the fault associations includes the fault diagnosis module 108 constructing the data-driven models 112 such that each data-driven model only represents a set of sensors that are mutually related through a common component. The fault diagnosis module 108 can then apply the physics-based knowledge from the first step to capture the fault associations between the resulting data-driven model residuals and possible faults.

In the first step, the fault diagnosis module 108 includes additional sensors that may be useful for data-driven modeling and any physics-based knowledge relevant to the additional sensors into the fault diagnosis device 102 (e.g., in memory 106). For example, bearing vibration and bearing temperature sensors, though not utilized by a physics-based modeling approach for centrifugal pumps, provide useful insights when incorporated in data-driven models. Such sensors provide indications of fault-induced process variable deviations that are not modeled using physics but are indicative of particular faults for a component and/or sensors.

In the second step, the fault diagnosis module 108 constructs data-driven models to cover an individual component and the associated process variables (e.g., via relevant sensors). However, the available sensor set in a system is often limited and it may not always be possible for the fault diagnosis module 108 to construct a data-driven model for each standalone component. Mathematically, this circumstance means that the local sensor set of a component is incomplete (i.e., insufficient) and it is not possible to monitor the component health status relying solely on the available sensors. Said another way, the fault diagnosis module 108 being unable to construct a data-driven model because the local sensor set is incomplete indicates that the degree of freedom of the underlying process is higher than the number of available sensor measurements. However, the techniques of the present disclosure overcome these challenges by creating virtual sensors in place of the missing sensors and extending the model construction to cover several adjacent components, to the degree allowed by the sensor set, when standalone component models are not possible. The fault diagnosis module 108 leverages virtual sensor creation to determine minimal combinations of components and local sensor sets to control the construction of the data-driven models.

As part of this process to determine fault associations, the fault diagnosis module 108 decomposes a system into separate minimal subsystems. Each of the minimal subsystems is a group of a minimum number of physically coupled components such that the local sensor set within the subsystem is sufficient for monitoring the components. Conventional data-driven approaches generally provide no basis for determining if a sensor set is sufficient for monitoring purposes. To overcome these issues with conventional approaches, the fault diagnosis module 108 utilizes the physics-based analytical capabilities described herein to decompose the system. The fault diagnosis module 108 then constructs data-driven models for each of the minimal subsystems using the local sensor sets.

More specifically, the fault diagnosis module 108 performs system decomposition in two general steps. First, the fault diagnosis module 108 analyzes a system P&ID and determines all physics-based component models that can be constructed for the system. Each of these physics-based component models necessarily has a sufficient sensor set for the related components. However, the sensor set for each model may contain virtual sensors created and utilized by the fault diagnosis module 108. The fault diagnosis module 108 creates each virtual sensor based on location data and types of other real sensors and components. As previously indicated, the term “sufficient” connotes that the sensor set provides the model with requisite utility for fault diagnosis.

The fault diagnosis module 108 then defines the components included as part of each subsystem based on the types of sensors present within the subsystem. Namely, for each available physics-based model, the fault diagnosis module 108 determines whether the sensor set contains only real sensors or if the sensor set includes at least one virtual sensor. If the fault diagnosis module 108 determines that only real sensors are present within the sensor set, then the module 108 determines that the components included in the subsystem represent a minimal subsystem. Accordingly, the fault diagnosis module 108 defines the sensor set for data-driven models of this minimal subsystem as the original sensor set (e.g., for the physics-based model) combined with any additional sensors indicated in a component library (e.g., as stored in memory 106, system diagrams 122, and/or the system 140 and included for the data-driven models).

However, if the fault diagnosis module 108 determines that the sensor set contains virtual sensors, then the module 108 expands the group of components in the subsystem to eventually eliminate all virtual sensors. The fault diagnosis module 108 may include, for example, other components involved in the creation of each virtual sensor in the sensor set. When the fault diagnosis module 108 determines that all virtual sensors are eliminated from the sensor set, the module 108 may define the resulting group of components as a minimal subsystem. Accordingly, the sensor set for the minimal subsystem includes the original sensor set and any additional sensors detailed in the memory 106, system diagrams 122, and/or the system 140 for each added component.

With the minimal subsystems defined, the fault diagnosis module 108 can systematically derive the fault associations between the data-driven model residuals and the related sensor measurements using the underlying physics knowledge base of the components in each minimal subsystem. It will be appreciated that the sensor set for each minimal subsystem is sufficient for a corresponding physics-based model (i.e., sufficient for monitoring the underlying physical constraints) and may include additional sensors for data-driven models, such that its sufficiency for the data-driven models is guaranteed.

To demonstrate decomposing a system for data-driven models, FIG. 3A is a schematic diagram illustrating an example high-pressure feedwater system 300 with sensor locations. The example high-pressure feedwater system 300 generally includes two heating stages 302a, 302d responsible for the supply of preheated feedwater to steam generators. Each stage 302a, 302d consists of two feedwater heaters (e.g., 304a, 304b) in parallel piping lines. As illustrated in FIG. 3A, the example high-pressure feedwater system 300 also includes three feed pumps 302b and three drain pumps 302c. Each subsystem (302a, 302b, 302c, 302d) includes at least one physics-based model and at least one data-driven model.

Initially, the fault diagnosis module 108 avoids constructing a data-driven model for the whole system because, due to the high number of components and sensors, it would then be practically impossible for the module 108 to derive the fault associations between the various faults and model residuals. The fault diagnosis module 108 is also typically unable to construct a data-driven model for each standalone component, as most components do not have a sufficient sensor set. Instead, the fault diagnosis module 108 decomposes the system into smaller blocks, sets, stages, etc. Each set/stage may contain one or more components that meets the sensor set requirements while allowing the fault diagnosis module 108 to derive the necessary fault associations based on physics-based relationships of the individual components.

For example, each standalone drain pump model of the three drain pumps 302c includes three real sensors (e.g., inlet and outlet pressure, outlet flowrate). In this example, the fault diagnosis module 108 evaluates each drain pump as an isolated subsystem and constructs data driven models for these three isolated subsystems using the three sensors and any additional sensors available (e.g., vibration sensors).

More generally, when decomposing the example high-pressure feedwater system 300 the fault diagnosis module 108 identifies an applicable physics-based model for each of the two heating stages 302a, 302d and each of the two pump sets 302b, 302c. The fault diagnosis module 108 may identify multiple applicable physics-based models for any given component set. For example, the fault diagnosis module 108 may evaluate the example high-pressure feedwater system 300 and determine that each standalone pump within the pump sets 302b, 302c may have an applicable physics-based model (i.e., three physics-based models). The fault diagnosis module 108 may also determine that each feedwater heater (e.g., 304a, 304b) in the two heating stages 302a, 302d may have an applicable physics-based model, such as a heat transfer model. In general, the fault diagnosis module 108 may determine any suitable number of physics-based models apply to the respective heating stages 302a, 302d or pumps 302b, 302c. Accordingly, the Nth physics-based model 306b3 may represent any integer value physics-based model greater than one.

The fault diagnosis module 108 may also construct any suitable number of data-driven models to describe the systems/subsystems at any suitable level of granularity. For example, the fault diagnosis module 108 examines the first heating stage 302a and determines that the individual feedwater heaters 304a, 304b have a sufficient number/type of surrounding sensors and/or additional components to construct a data-driven model. The fault diagnosis module 108 then constructs a data-driven model 306a1, 306a3 for both feedwater heaters 304a, 304b. Of course, it should be appreciated that the fault diagnosis module 108 may create any suitable number of data-driven models (e.g., 306a1, 306a3) for any system/subsystem. Accordingly, the Nth data-driven model 306a3 may represent any integer value data-driven model greater than one.

However, as previously mentioned, some subsystems may include virtual sensors as part of the physics-based model identification/application. For example, the heat transfer models 306a2, 306a4 for each feedwater heater 304a, 304b in the first heating stage 302a rely on data corresponding to several virtual sensors. The virtual sensors required for the first feedwater heater 304a include an inlet feedwater flowrate sensor, an inlet steam flowrate sensor, and a steam enthalpy/quality sensor. These virtual sensors are obtained from solving mass and energy balance equations between the two feedwater heaters 304a, 304b. To obtain a minimal subsystem containing the first feedwater heater 304a, the fault diagnosis module 108 expands the boundary of included sensors/components to cover the sensors and components involved in creating these virtual sensors. As a result, the fault diagnosis module 108 identifies a minimal subsystem (i.e., the first stage 302a) that includes the first and second feedwater heaters 304a, 304b, the sensors surrounding both heaters 304a, 304b, as well as a flowrate sensor on the downstream of both heaters 304a, 304b. With this minimal subsystem, the fault diagnosis module 108 can proceed with creating the data-driven models 306a1, 306a3 and deriving/determining the required fault associations from first-principles.

To provide a clearer understanding of the components and sensors included in the first stage 302a, FIG. 3B is a schematic diagram of the first stage 302a of the example high-pressure feedwater system 300 from FIG. 3A. The schematic diagram is an example P&ID, which may correspond to a system description that the fault diagnosis device 102 can receive.

The first stage 302a includes a first feedwater heater (FWH) 304a and a second FWH 304b. The labels S, D1, D2, E1, E2, F1, F2, G1, G2, and K are labels corresponding to locations of the first stage 302a. The labels D1, E1, F1, and G1 correspond to the steam inlet, feedwater inlet, feedwater outlet, and drain of the first FWH 304a, respectively. The labels D2, E2, F2, and G2 correspond to the steam inlet, feedwater inlet, feedwater outlet, and drain of the second FWH 304b, respectively. The label S corresponds to a starting location of steam in the first stage 302a, and the label K corresponds to an ending location of feedwater in the first stage 302a with a corresponding flow rate sensor 321.

Five sensors are associated with the FWH 304a: steam inlet pressure sensor 312, feedwater inlet temperature sensor 314, feedwater outlet temperature sensor 316, drain temperature sensor 318, and drain flow rate sensor 320. Similarly, five sensors are associated with the FWH 304b: steam inlet pressure sensor 322, feedwater inlet temperature sensor 324, feedwater outlet temperature sensor 326, drain temperature sensor 328, and drain flow rate sensor 330. Thus, the first stage 302a is missing at least one sensor to construct physics-based models for each of the FWHs 304a and 304b. In particular, each of the FWHs 304a and 304b is missing a feedwater flow rate sensor. Further, the FWHs 304a and 304b are also missing steam inlet quality sensors, which some physics-based models rely upon.

Accordingly, the fault diagnosis module 108 can construct the following loop balance equations for the first stage 302a based on the schematic diagram, where the subscripts indicate the location of the measurement:

$${w}_{F 1} + {w}_{F 2} = {w}_{K} \qquad ( Equation 1 )$$

$${h}_{D 1} = {h}_{S} \qquad ( Equation 2 )$$

$${h}_{D 2} = {h}_{S} \qquad ( Equation 3 )$$

$${w}_{F 1} ( {h}_{F 1} - {h}_{E 1} ) = {w}_{G 1} ( {h}_{D 1} - {h}_{G 1} ) \qquad ( Equation 4 )$$

$${w}_{F 2} ( {h}_{F 2} - {h}_{E 2} ) = {w}_{G 2} ( {h}_{D 2} - {h}_{G 2} ) \qquad ( Equation 5 )$$

The variables w_{F1}, w_{F2}, h_{D1}, h_{D2}, and h_{S} can be considered unknown variables because there are not sensors to directly measure these variables. The fault diagnosis module 108 can solve the system of equations provided by Equations 38-42 in order to solve for these unknown variables in terms of measurable variables. Thus, there are five virtual sensors corresponding to the expressions for these five unknown variables. Other loop balance equations can be written and other virtual sensors may be solved for. However, equations 1-5 can be used to solve for the virtual sensors required for at least one physics-based model(s) corresponding to the FWHs 304a and 304b.

In any event, the locations of the solvable virtual sensors are shown in FIG. 3B. In particular, the unknown variables w_{F1}, w_{F2}, h_{D1}, h_{D2}, and h_{S} correspond to virtual sensors 332, 334, 336, 338, and 339, respectively. Accordingly, the fault diagnosis module 108 can now construct physics-based models for the FWHs 304a and 304b using the physical and virtual sensors. As previously discussed, one or more of the virtual sensors 332, 334, 336, 338, and 339 may be type-I virtual sensors or type-II virtual sensors.

For an example of two type-II virtual sensors, consider the two (type-I) virtual sensors 332 and 334 that were obtained by solving Equations 1-5. The fault diagnosis module 108 can use these two virtual sensors, and the fact that the FWH 304a and the FWH 304b are connected in parallel, to construct a flow ratio model. The prediction of the calibrated flow ratio model can then be used to compute the two flow rates w_{F1}, w_{F2} without relying on the two virtual sensors 332 and 334. As a result, there are two type-II virtual sensors for the flow rates at locations F1 and F2. These two type-II virtual sensors have different validity conditions compared to the virtual sensors 332 and 334 and can be used to generate additional residuals for the two FWHs 304a and 304b.

Regardless, when the fault diagnosis module 108 decomposes a system and/or sensor set into minimal subsets and generates relevant physics-based models, the module 108 can construct data-driven models and determine the necessary fault associations between data-driven model residuals and faults of components and/or sensors of the minimal subsets. For example, the fault diagnosis module 108 may construct a data-driven model (e.g., data-driven model 306a1) for the first stage 302a as an MSET model. In this example, the fault diagnosis module 108 constructs the MSET model based on historical operating data of the first stage 302a that is a priori known to represent “normal” operating conditions for the components/sensors of the first stage 302a. Thus, residuals output by the MSET model generally represent a degree to which the modeled system (e.g., first stage 302a) has deviated from such normal operating conditions. However, without additional information relating the residuals to the underlying physics of the modeled system, the residuals would not have as much value acting as fault symptoms within the combined diagnostic framework described herein.

FIG. 3C is an example data workflow 340 including the data-driven model 306a1 associated with the first stage 302a of FIG. 3B. The example data workflow 340 generally represents the fault diagnosis module 108 determining fault associations for the data-driven model 306a1 using underlying physical knowledge (e.g., P&ID) of the corresponding components/sensors. The example data workflow 340 illustrated in FIG. 3C includes the data-driven model 306a1 generating a residual, which is analyzed in tandem with the P&ID at a fault association stage 342 to determine the fault association(s). The fault association stage 342 may generally represent analysis performed by any suitable processor (e.g., processor 104) executing any suitable instructions (e.g., fault diagnosis module 108).

Broadly, the fault association represents a cause-and-effect relationship between the residual output by the data-driven model 306a1 and one or more particular faults that are known to possibly occur within the modeled system (i.e., first stage 302a). When the data-driven model 306a1 outputs the residual during a real-time fault diagnostic operation, the fault diagnosis module 108 may analyze the fault association corresponding to the residual and determine/identify one or more faults of a component or a sensor which likely caused the data-driven model 306a1 to output the (non-zero) residual.

The workflow represented by the example data workflow 340 may be performed for each residual that is output by the data-driven model 306a1. The P&ID serves to inform this process by enabling the determination of relevant component/sensor subsets involved in a physical process. The fault association stage 342 can then determine fault associations for each residual of the data-driven model by evaluating which components/sensors contributed data resulting in the data-driven model 306a1 generating the residual, such that the residual is most likely to represent a particular set of component/sensor faults. Of course, the example data workflow 340 is for the purposes of discussion only, and determining fault associations between residuals and potential faults of a system may be accomplished using any suitable information indicating physical relationships of system components/sensors (e.g., P&ID) and/or underlying physics-based performance of the system (e.g., physics-based models).

### Example Combined Diagnostic Framework Application

To demonstrate the combined diagnostic framework, consider an example involving a reactor feedwater pump. In particular, the system of interest is a centrifugal pump (“reactor feed pump”) driven by an induction motor. The motors operate in fixed speed mode with no active control of the shaft speed. FIG. 4A is an example reactor feed pump system with several performance sensors and two other sensors measuring physical phenomena that are not used as inputs to a physics-based model. The example reactor feed pump system is illustrated as a single block with multiple connected sensors for the purposes of simplicity, and thus does not depict every internal and/or otherwise connected component (e.g., motor, pump, bearings, etc.) comprising the reactor feed pump. Nevertheless, such components are included as part of the example reactor feed pump system, and are discussed herein.

The example reactor feed pump system includes the reactor feed pump components 400, multiple performance sensors 402a-n, and two other sensors 404a, 404b. The reactor feed pump components 400 includes all components required to operate a reactor feed pump, including a pump, a motor, bearings, and/or other components. The multiple performance sensors 402a-n include sensors that measure process variables that can be included in a first-principles approach to modeling the performance of the reactor feed pump components 400 (e.g., a physics-based model). The two other sensors 404a, 404b measure physical phenomena that are not used as part of such a first-principles approach but can be implemented as part of a data-driven approach. The multiple performance sensors 402a-n may include any suitable number of sensors, such that the Nth performance sensor 402n may be any suitable integer value greater than or equal to one. While illustrated as two other sensors 404a, 404b, it should be appreciated that such illustration is for the purposes of clarity, and that there may be any number of other sensors measuring physical phenomena that are not used as part of such a first-principles approach.

As an example, the multiple performance sensors 402a-n include six sensors that measure motor power, motor current, shaft speed, pump volumetric flowrate, pump suction pressure, and the pump discharge pressure. With these six sensors, the fault diagnosis module 108 can construct four physics-based diagnostic models, including a motor power model, a motor current model, a pump head model, and a total motor-pump power model. Each model was calibrated (i.e., trained) using a training data set obtained during a system startup.

These four models can generate six model residuals, listed below:
r_{m,P}: computed from the motor power model as a function of shaft speed;
r_{m,I}: computed from the motor current model as a function of shaft speed;
r_{p,Δp}: computed from the pump head model as a function of pump volumetric flowrate and shaft speed;
r_{c,P}: computed from the total motor-pump power model as a function of pump volumetric flowrate and shaft speed;
r_{m,P2}: computed from the motor power model as a function of a predicted shaft speed value;
r_{c,P2}: computed from the total motor-pump power model as a function of a predicted pump volumetric flowrate and shaft speed.

When characterizing component faults for this example reactor feed pump system, it is convenient to consider bearing faults and other shaft-friction-related faults as one fault type. Thus, component faults in this combined reactor feed pump system can be put into three categories: pump faults, motor faults, and bearings faults. The behavior of the combined system under the faults can be summarized by the fault-signature of single-fault events listed in Table 1 below. These unique fault-signatures for each single-fault event enables the fault diagnosis module 108 to discriminate between the faults when performing fault diagnostics.

TABLE 1
Fault Signatures for the Reactor Feed Pump System of FIG. 4A

| | Component Faults | | | Sensor Faults | | | | |
|---|---|---|---|---|---|---|---|---|
| Residuals | Motor | Bearings | Pump | Pₘ | I | n | Q | pᵢₙ/pₒᵤₜ |
| r_{m, P} | 1 | 0 | 0 | 1 | 0 | 1 | 0 | 0 |
| r_{m, I} | 1 | 0 | 0 | 0 | 1 | 1 | 0 | 0 |
| r_{p, Δp} | 0 | 0 | 1 | 0 | 0 | 1 | 1 | 1 |
| r_{c, P} | 1 | 1 | 1 | 1 | 0 | 1 | 1 | 0 |
| r_{m, P2} | 1 | 0 | 0 | 1 | 1 | 0 | 0 | 0 |
| r_{c, P2} | 1 | 1 | 1 | 1 | 0 | 1 | 0 | 1 |

Continuing the example of the reactor feed pump system of FIG. 4A, assume that the example reactor feed pump system experiences a fault at a particular time instance. Referring to FIG. 4B, this fault is represented as a substantial drop in the gross load (e.g., in megawatts (MW)) output by a generator, of which, the reactor feed pump system of FIG. 4A is a subsystem.

More generally, FIG. 4B is an example graph 410 illustrating the gross load of a generator over time, wherein the generator utilizes a reactor feed pump configured similarly to the example reactor feed pump of FIG. 4A. As indicated in the example graph 410, at a time instance approximately between 10:30 to 16:00, the reactor feed pump system of FIG. 4A experienced a fault. This fault eventually caused a consistent drop in gross load over the subsequent six to eight hours before the gross load rebounded and stabilized at a new, lower total output than prior to the fault.

In this example, the fault diagnosis module 108 can utilize the available sensors of the reactor feed pump system (e.g., 402a-n, 404a, 404b) to detect and diagnose a pump fault in the reactor feed pump components 400 approximately at the time instance represented in the example graph 410 (i.e., between 10:30 and 16:00) and quantify the resulting performance degradation of the system. The fault diagnosis module 108 analyzes each residual to determine non-zero residuals. In this example, the fault diagnosis module 108 determines that the residuals r_{p,Δp}, r_{c,P}, and r_{c,P2} are non-zero, maps that determination back to the set of fault signatures (e.g., represented in Table 1), and further determines a pump fault in the reactor feed pump components 400 is the correct fault diagnosis.

The fault diagnosis module 108 will also analyze the sensor measurements associated with the fault of the reactor feed pump system by applying the data-driven models. For this analysis, the fault diagnosis module 108 considers data acquired by the six sensors used in the physics-based approach (e.g., performance sensors 402a-n) along with the other sensors (e.g., sensors 404a, 404b). In this example, the sensors 404a, 404b include vibration sensors and temperature sensors measuring vibrations/temperatures of inboard and outboard pump bearings.

FIG. 4C is an example graph 420 illustrating vibration levels over time at inbound and outbound bearing locations for the pump (e.g., reactor feed pump components 400) of FIG. 4A. As depicted in the example graph 420, the vibration levels of the inbound and outbound bearing locations began to deviate from normal levels at approximately 10:30. The vibration levels continued to deviate more substantially from normal levels, until at approximately 15:00, the vibration levels at both inbound and outbound locations spiked. The vibration levels at the outbound bearing location remained under the high limit, but the vibration levels at the inbound bearing location exceeded the high limit, thereby triggering an alarm.

These vibration sensor measurements enable the fault diagnosis module 108 to quickly detect and trigger an alarm to prevent and/or mitigate the deleterious effects of such mechanical faults in the reactor feed pump in a manner that the physics-based models and residuals may not. This vibration data is not measured and/or otherwise directly accounted for by the physics-based models, such that the physics-based models may experience delayed detection of such mechanical failure. The physics-based models would only detect the fault as a result of sensor data that is indirectly correlated to the fault, and thus the detection is likely not as definitive or timely as the data-driven model outputs based on the vibration sensor data.

FIG. 4D is an example graph 430 illustrating temperature values over time for the inbound and outbound bearing locations of the pump referenced in FIG. 4A. Similar to the bearing vibration values, the bearing temperatures began noticeably deviating at approximately 10:30. In particular, the bearing temperatures generally increased as the motor power (and pump load) reduced, which also correlates to the rotational shaft speed increasing with reduced pump load. Interestingly, the increased bearing vibrations (e.g., spike at approximately 15:00 in FIG. 4C) in the reactor feed pump did not appear to cause any other abnormal behavior in the bearing temperatures. Put simply, there appeared to be no correlation between the increased bearing vibrations and the temperature profiles.

In any event, the fault diagnosis module 108 may analyze these temperature values similarly to the vibration values to potentially determine faults that the physics-based models cannot and/or to enable a determination between several faults. For example, the fault diagnosis module 108 may utilize the bearing temperature measurements to detect bearing faults that cause an increase in the shaft friction, as the energy loss is converted to heat. Moreover, the fault diagnosis module 108 can utilize the bearing vibration values and temperature values independently for different types of pump and/or bearing faults.

As a result of the sensors measuring the data represented in the graphs of FIGS. 4B-4D (and others), the fault diagnosis module 108 can perform a full diagnostic analysis to determine a fault. FIG. 4E is an example diagnostics workflow 440 to determine a fault of a component or a sensor based on sensor measurements and a combined diagnostic framework. Broadly, the example diagnostics workflow 440 includes a data-driven model 442a and a physics-based model 442b receiving sensor measurements as inputs, both models 442a, 442b generating residuals, and utilizing the residuals and a combined reasoning table 446 to determine a fault at a combined reasoning stage 444. As discussed herein, the combined reasoning stage 444 may represent any suitable processors (e.g., processor 104) executing any suitable applications or other instructions (e.g., fault diagnosis module 108) to perform the actions described herein.

From each non-zero model residual, the fault diagnosis module 108 can determine the possible faults within the system. For example, as indicated by the fault-signatures in Table 1, the possible faults from the detected non-zero residuals in this case are:
If r_{p,Δp}≠0 then: Pump Fault or some Sensor Fault (Speed or Flowrate or Pressure);
If r_{c,P}≠0 then: Motor or Bearing or Pump or some other Sensor Faults;
If r_{c,P2}≠0 then: Motor or Bearing or Pump or some other Sensor Faults.

For each residual the fault diagnosis module 108 determines as zero, the module 108 can exonerate (i.e., eliminate) certain faults associated with those residuals. Combining the logic from all model residuals, the fault diagnosis module 108 can then arrive at the final diagnosis of a pump fault, in the case of the graphs 410-430 of FIGS. 4B-4D.

To integrate the data-driven approach into this process, the fault diagnosis module 108 derives and represents the fault associations (i.e., cause-effect relations) between the data-driven residuals and the faults in a same/similar format. For ease of discussion only, the fault diagnosis module 108 will construct only simple univariate models utilizing bearing vibration sensor(s) (e.g., inboard/outboard bearing vibration sensor) and bearing temperature sensors, as previously described.

The fault diagnosis module 108 compares the measured value from each sensor against a prescribed threshold and an alarm is triggered when the sensor value exceeds the threshold. Additionally, the alarm can be triggered when the model residual exceeds a threshold value. In certain embodiments, the model residual can be computed as the difference between the sensor reading and the threshold.

Further, the fault diagnosis module 108 can derive the fault associations between these residuals and the possible faults from qualitative understandings of the behavior of the component and incorporated into the system (e.g., stored in memory 106, system diagrams 122, system 140). As an example, an increase in bearing vibration could be caused by either a pump fault (e.g., pump instability issues) or a bearing fault. By contrast, the bearing temperature is only affected by a bearing fault. Ignoring the sensor fault possibilities, the fault associations for these residuals are therefore represented by the fault signatures in Table 2.

TABLE 2
Fault Signatures of the Data-Driven Residuals

| | Pump Fault | Pump Fault | |
|---|---|---|---|
| Residuals | Category 1 | Category 2 | Bearing Fault |
| r_{vibr.} | 1 | 0 | 1 |
| r_{temp.} | 0 | 0 | 1 |

As can be seen in Table 2, both category 1 and 2 pump faults are ostensibly indicated by a zero value for the temperature residual. Thus, without the vibration sensor, the fault diagnosis module 108 would be unable to determine the correct category of any pump fault. The category 1 pump fault is any instability issue resulting in increased vibrations. The category 2 pump fault is a pure loss of pump efficiency without any instability issues.

With both sets of fault signatures, the fault diagnosis module 108 can fully utilize the knowledge from both the physics-based models and the data-driven models. More specifically, the combined sets of fault signatures for both physics-based and data-driven models enables the fault diagnosis module 108 to create a combined reasoning table (e.g., combined reasoning table 446) to determine faults of components or sensors. The combined reasoning table 446 for the example reactor feed pump is reproduced below in Table 3.

TABLE 3
Combined Reasoning Table

| Logic | | | |
|---|---|---|---|
| Rule | Antecedent Value | | Consequent Value |
| 1 | High Bearing Vibration | then | Bearing Fault |
| | | | or |
| | | | Pump Fault Category 1 |
| 2 | Normal Bearing Temp. | then | Not Bearing Fault |
| 3 | Pump Performance (3 zero, 3 | then | Pump Fault Category 1 |
| | non-zero physics-based residuals) | | or |
| | | | Pump Fault Category 2 |

Output: Pump Fault Category 1

As represented in Table 5, the third logic rule (“Pump Performance”) represents the reasoning process contribution form the physics-based models. This third logic rule, in fact, consists of six logical statements (one from each model residual, as indicated in Table 1) that led the fault diagnosis module 108 to previously determine the pump fault diagnosis on the basis of only the physics-based model residuals (e.g., from physics-based model 442b). Thus, the pump fault indicated on that basis includes any issue that could affect the hydraulic performance of the pump.

However, when the data-driven model 442a residuals are received at the combined reasoning stage 444, the fault diagnosis module 108 evaluates both sets of residuals to determine and/or further refine the fault diagnosis. In this example, the sensor measurements from the vibration sensor(s) help improve the diagnostic framework by narrowing the fault diagnosis down to a pump fault category 1 (i.e., instability issue caused by mechanical damage), instead of a more generic pump fault. Thus, the combined data-driven and physics-based model approach achieves a more granular/specific fault diagnosis than the fault diagnosis module 108 would have otherwise determined on the basis of either model residuals independently.

### Example Methods for Diagnosing Equipment Faults as Constrained by Data and Physics

FIG. 5 is a flow diagram of an example method 500 for diagnosing faults using a combined data-driven model and physics-based model approach. It should be appreciated that actions of the example method 500 may be performed by and/or in combination with various components described herein (e.g., processor 104, fault diagnosis module 108).

At block 502, the example method 500 includes receiving a description of a sensor set of a thermal hydraulic system, the description indicating, for each sensor of the sensor set, a sensor type and a location. The example method 500 further includes decomposing the sensor set into a plurality of sensor subsets (block 504). Each sensor subset of the plurality of sensor subsets includes sensors configured to monitor a physical process within the thermal hydraulic system that can be described using a physics-based model based on the sensor types and the locations. In certain embodiments, the example method 500 includes decomposing systems and/or component sets into subsets based on a P&ID.

The example method 500 further includes constructing a data-driven model for each sensor subset of the plurality of sensor subsets (block 506). The example method 500 further includes determining a fault association for each residual of each data-driven model (block 508). The fault associations correspond to a sensor fault or a component fault within the thermal hydraulic system.

The example method 500 further includes receiving sensor measurements captured by sensors of a first sensor subset of the plurality of sensor subsets at a time instance (block 510). The example method 500 further includes calculating residuals of (i) the data-driven model corresponding to the first sensor subset and (ii) a physics-based model corresponding to the first sensor subset (block 512). The example method 500 further includes determining a fault of a component or a sensor of the first sensor subset that is present at the time instance based on the residuals (block 514). The example method 500 further includes generating an alert indicating that the fault is present in the component or the sensor (block 516).

The method of aspect 1, wherein determining the fault of the component or the sensor further comprises: determining, by the one or more processors, a first fault set including one or more faults indicated by one or more residuals of the data-driven model; determining, by the one or more processors, a second fault set including one or more faults indicated by one or more residuals of the physics-based model; and determining, by the one or more processors, the fault of the component or the sensor by identifying the fault is consistent with the first fault set and the second fault set.

In certain embodiments, the example method 500 further includes creating a first virtual sensor set associated with the first sensor subset; determining a physics-based model set available to characterize a first physical process monitored by the first sensor subset based on the first virtual sensor set; creating a second virtual sensor set associated with the first sensor subset; and selecting the physics-based model corresponding to the first sensor subset from the physics-based model set to characterize the first physical process based on the second virtual sensor set. Further in these embodiments, the first virtual sensor set includes at least one model-driven virtual sensor and the second virtual sensor set includes at least one data-driven virtual sensor.

In some embodiments, the data-driven model is a multivariate state estimation technique (MSET) model. In certain embodiments, the residuals correspond to differences between measurements predicted by (i) the data-driven model or (ii) the physics-based model and the sensor measurements.

In certain embodiments, receiving the description includes receiving a piping and instrumentation diagram (P&ID) including components associated with the sensor set. Further in these embodiments, determining the fault association for each residual of each data-driven model further includes determining a component subset of the components associated with the sensor set that are involved in a first physical process monitored by the first sensor subset based on the P&ID; and determining fault associations for residuals of the data-driven model corresponding to the first sensor subset corresponding to one or more component faults of the component subset based on the P&ID.

In some embodiments, the example method 500 further includes constructing the physics-based model corresponding to the first sensor subset based on a physical conservation law including at least one of: (i) conservation of mass, (ii) conservation of energy, or (iii) conservation of momentum. Further in these embodiments, constructing the physics-based model further includes retrieving the physics-based model from a database including a plurality of physics-based models based on (i) a type of a component associated with the first sensor subset and (ii) the description of the sensors of the first sensor subset.

In certain embodiments, calculating the residuals further comprises determining whether a particular residual of the residuals is statistically non-zero by estimating a standard deviation and a mean of the particular residual using historical measurements; and determining that the particular residual is statistically non-zero if, for the particular residual at the time instance, a decision function of a statistical change algorithm exceeds a threshold.

In some embodiments, the alert further indicates a probability of the fault. In certain embodiments, the example method 500 further includes determining an action to address the fault; and transmitting a control instruction to a controller of the thermal hydraulic system to perform the action. Further, depending on the implementation, the fault diagnosis device 102 can report any quantities or expressions (e.g., the physics-based models, the residual expressions, the residuals (e.g., at any time step or at several time steps), and/or the identified faults (e.g., at any time step or at several time steps) as part of an alert.

### Aspects

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

1. A method for diagnosing faults, the method comprising: receiving, at one or more processors, a description of a sensor set of a thermal hydraulic system, the description indicating, for each sensor of the sensor set, a sensor type and a location; decomposing, by the one or more processors, the sensor set into a plurality of sensor subsets, each sensor subset of the plurality of sensor subsets including sensors configured to monitor a physical process within the thermal hydraulic system that can be described using a physics-based model based on the sensor types and the locations; constructing, by the one or more processors, a data-driven model for each sensor subset of the plurality of sensor subsets; determining, by the one or more processors, a fault association for each residual of each data-driven model, the fault association corresponding to a sensor fault or a component fault within the thermal hydraulic system; receiving, by the one or more processors, sensor measurements captured by sensors of a first sensor subset of the plurality of sensor subsets at a time instance; calculating, by the one or more processors, residuals of (i) the data-driven model corresponding to the first sensor subset and (ii) a physics-based model corresponding to the first sensor subset; determining, by the one or more processors, a fault of a component or a sensor of the first sensor subset that is present at the time instance based on the residuals; and generating, by the one or more processors, an alert indicating that the fault is present in the component or the sensor.

2. The method of aspect 1, wherein determining the fault of the component or the sensor further comprises: determining, by the one or more processors, a first fault set including one or more faults indicated by one or more residuals of the data-driven model; determining, by the one or more processors, a second fault set including one or more faults indicated by one or more residuals of the physics-based model; and determining, by the one or more processors, the fault of the component or the sensor by identifying the fault is consistent with the first fault set and the second fault set.

3. The method of any of aspects 1 or 2, further comprising: creating, by the one or more processors, a first virtual sensor set associated with the first sensor subset; determining, by the one or more processors, a physics-based model set available to characterize a first physical process monitored by the first sensor subset based on the first virtual sensor set; creating, by the one or more processors, a second virtual sensor set associated with the first sensor subset; and selecting, by the one or more processors, the physics-based model corresponding to the first sensor subset from the physics-based model set to characterize the first physical process based on the second virtual sensor set.

4. The method of aspect 3, wherein the first virtual sensor set includes at least one model-driven virtual sensor and the second virtual sensor set includes at least one data-driven virtual sensor.

5. The method of any of aspects 1 through 4, wherein the data-driven model is a multivariate state estimation technique (MSET) model.

6. The method of any of aspects 1 through 5, wherein the residuals correspond to differences between measurements predicted by (i) the data-driven model or (ii) the physics-based model and the sensor measurements.

7. The method of any of aspects 1 through 6, wherein receiving the description includes receiving a piping and instrumentation diagram (P&ID) including components associated with the sensor set.

8. The method of aspect 7, wherein determining the fault association for each residual of each data-driven model further comprises: determining, by the one or more processors, a component subset of the components associated with the sensor set that are involved in a first physical process monitored by the first sensor subset based on the P&ID; and determining, by the one or more processors, fault associations for residuals of the data-driven model corresponding to the first sensor subset corresponding to one or more component faults of the component subset based on the P&ID.

9. The method of any of aspects 1 through 8, further comprising: constructing, by the one or more processors, the physics-based model corresponding to the first sensor subset based on a physical conservation law including at least one of: (i) conservation of mass, (ii) conservation of energy, or (iii) conservation of momentum.

10. The method of aspect 9, wherein constructing the physics-based model further includes: retrieving, by the one or more processors, the physics-based model from a database including a plurality of physics-based models based on (i) a type of a component associated with the first sensor subset and (ii) the description of the sensors of the first sensor subset.

11. The method of any of aspects 1 through 10, wherein calculating the residuals further comprises determining whether a particular residual of the residuals is statistically non-zero by: estimating, by the one or more processors, a standard deviation and a mean of the particular residual using historical measurements; and determining, by the one or more processors, that the particular residual is statistically non-zero if, for the particular residual at the time instance, a decision function of a statistical change algorithm exceeds a threshold.

12. The method of any of aspects 1 through 11, wherein the alert further indicates a probability of the fault.

13. The method of any of aspects 1 through 12, further comprising: determining, by the one or more processors, an action to address the fault; and transmitting, by the one or more processors, a control instruction to a controller of the thermal hydraulic system to perform the action.

14. A computer system for diagnosing faults, the computer system comprising: one or more processors; and a non-transitory computer-readable medium storing thereon instructions that, when executed by the one or more processors, cause the computer system to: receive a description of a sensor set of a thermal hydraulic system, the description indicating, for each sensor of the sensor set, a sensor type and a location, decompose the sensor set into a plurality of sensor subsets, each sensor subset of the plurality of sensor subsets including sensors configured to monitor a physical process within the thermal hydraulic system that can be described using a physics-based model based on the sensor types and the locations, construct a data-driven model for each sensor subset of the plurality of sensor subsets, determine a fault association for each residual of each data-driven model, the fault association corresponding to a sensor fault or a component fault within the thermal hydraulic system, receive sensor measurements captured by sensors of a first sensor subset of the plurality of sensor subsets at a time instance, calculate residuals of (i) the data-driven model corresponding to the first sensor subset and (ii) a physics-based model corresponding to the first sensor subset, determine a fault of a component or a sensor of the first sensor subset that is present at the time instance based on the residuals, and generate an alert indicating that the fault is present in the component or the sensor.

15. The computer system of aspects 14, wherein the instructions, when executed, further cause the computer system to determine the fault of the component or the sensor by: determining a first fault set including one or more faults indicated by one or more residuals of the data-driven model; determining a second fault set including one or more faults indicated by one or more residuals of the physics-based model; and determining the fault of the component or the sensor by identifying the fault is consistent with the first fault set and the second fault set.

16. The computer system of any of aspects 14 or 15, wherein the instructions, when executed, further cause the computer system to: create a first virtual sensor set associated with the first sensor subset; determine a physics-based model set available to characterize a first physical process monitored by the first sensor subset based on the first virtual sensor set; create a second virtual sensor set associated with the first sensor subset; and select the physics-based model corresponding to the first sensor subset from the physics-based model set to characterize the first physical process based on the second virtual sensor set.

17. The computer system of aspect 16, wherein the first virtual sensor set includes at least one model-driven virtual sensor and the second virtual sensor set includes at least one data-driven virtual sensor.

18. The computer system of any of aspects 14 through 17, wherein the data-driven model is a multivariate state estimation technique (MSET) model.

19. The computer system of any of aspects 14 through 18, wherein receiving the description includes receiving a piping and instrumentation diagram (P&ID) including components associated with the sensor set.

20. The computer system of aspect 19, wherein the instructions, when executed, further cause the computer system to determine the fault association for each residual of each data-driven model by: determining a component subset of the components associated with the sensor set that are involved in a first physical process monitored by the first sensor subset based on the P&ID; and determining fault associations for residuals of the data-driven model corresponding to the first sensor subset corresponding to one or more component faults of the component subset based on the P&ID.

### Additional Considerations

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Accordingly, the term hardware should be understood to encompass a tangible entity, which may be one of an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of exemplary functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors). These operations are accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for methods and systems for diagnosing faults through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for diagnosing faults, the method comprising:
receiving, at one or more processors, a description of a sensor set of a thermal hydraulic system, the description indicating, for each sensor of the sensor set, a sensor type and a location;
decomposing, by the one or more processors, the sensor set into a plurality of sensor subsets, each sensor subset of the plurality of sensor subsets including sensors configured to monitor a physical process within the thermal hydraulic system that can be described using a physics-based model based on the sensor types and the locations;
constructing, by the one or more processors, a data-driven model for each sensor subset of the plurality of sensor subsets;
determining, by the one or more processors, a fault association for each residual of each data-driven model, the fault association corresponding to a sensor fault or a component fault within the thermal hydraulic system;
receiving, by the one or more processors, sensor measurements captured by sensors of a first sensor subset of the plurality of sensor subsets at a time instance;
calculating, by the one or more processors, residuals of (i) the data-driven model corresponding to the first sensor subset and (ii) a physics-based model corresponding to the first sensor subset;
determining, by the one or more processors, a fault of a component or a sensor of the first sensor subset that is present at the time instance based on the residuals; and
generating, by the one or more processors, an alert indicating that the fault is present in the component or the sensor.

2. The method of claim 1, wherein determining the fault of the component or the sensor further comprises:
determining, by the one or more processors, a first fault set including one or more faults indicated by one or more residuals of the data-driven model;
determining, by the one or more processors, a second fault set including one or more faults indicated by one or more residuals of the physics-based model; and
determining, by the one or more processors, the fault of the component or the sensor by identifying the fault is consistent with the first fault set and the second fault set.

3. The method of claim 1, further comprising:
creating, by the one or more processors, a first virtual sensor set associated with the first sensor subset;
determining, by the one or more processors, a physics-based model set available to characterize a first physical process monitored by the first sensor subset based on the first virtual sensor set;
creating, by the one or more processors, a second virtual sensor set associated with the first sensor subset; and
selecting, by the one or more processors, the physics-based model corresponding to the first sensor subset from the physics-based model set to characterize the first physical process based on the second virtual sensor set.

4. The method of claim 3, wherein the first virtual sensor set includes at least one model-driven virtual sensor and the second virtual sensor set includes at least one data-driven virtual sensor.

5. The method of claim 1, wherein the data-driven model is a multivariate state estimation technique (MSET) model.

6. The method of claim 1, wherein the residuals correspond to differences between measurements predicted by (i) the data-driven model or (ii) the physics-based model and the sensor measurements.

7. The method of claim 1, wherein receiving the description includes receiving a piping and instrumentation diagram (P&ID) including components associated with the sensor set.

8. The method of claim 7, wherein determining the fault association for each residual of each data-driven model further comprises:
determining, by the one or more processors, a component subset of the components associated with the sensor set that are involved in a first physical process monitored by the first sensor subset based on the P&ID; and
determining, by the one or more processors, fault associations for residuals of the data-driven model corresponding to the first sensor subset corresponding to one or more component faults of the component subset based on the P&ID.

9. The method of claim 1, further comprising:
constructing, by the one or more processors, the physics-based model corresponding to the first sensor subset based on a physical conservation law including at least one of: (i) conservation of mass, (ii) conservation of energy, or (iii) conservation of momentum.

10. The method of claim 9, wherein constructing the physics-based model further includes:
retrieving, by the one or more processors, the physics-based model from a database including a plurality of physics-based models based on (i) a type of a component associated with the first sensor subset and (ii) the description of the sensors of the first sensor subset.

11. The method of claim 1, wherein calculating the residuals further comprises determining whether a particular residual of the residuals is statistically non-zero by:
estimating, by the one or more processors, a standard deviation and a mean of the particular residual using historical measurements; and
determining, by the one or more processors, that the particular residual is statistically non-zero if, for the particular residual at the time instance, a decision function of a statistical change algorithm exceeds a threshold.

12. The method of claim 1, wherein the alert further indicates a probability of the fault.

13. The method of claim 1, further comprising:
determining, by the one or more processors, an action to address the fault; and
transmitting, by the one or more processors, a control instruction to a controller of the thermal hydraulic system to perform the action.

14. A computer system for diagnosing faults, the computer system comprising:
one or more processors; and
a non-transitory computer-readable medium storing thereon instructions that, when executed by the one or more processors, cause the computer system to:
receive a description of a sensor set of a thermal hydraulic system, the description indicating, for each sensor of the sensor set, a sensor type and a location,
decompose the sensor set into a plurality of sensor subsets, each sensor subset of the plurality of sensor subsets including sensors configured to monitor a physical process within the thermal hydraulic system that can be described using a physics-based model based on the sensor types and the locations,
construct a data-driven model for each sensor subset of the plurality of sensor subsets,
determine a fault association for each residual of each data-driven model, the fault association corresponding to a sensor fault or a component fault within the thermal hydraulic system,
receive sensor measurements captured by sensors of a first sensor subset of the plurality of sensor subsets at a time instance,
calculate residuals of (i) the data-driven model corresponding to the first sensor subset and (ii) a physics-based model corresponding to the first sensor subset,
determine a fault of a component or a sensor of the first sensor subset that is present at the time instance based on the residuals, and
generate an alert indicating that the fault is present in the component or the sensor.

15. The computer system of claim 14, wherein the instructions, when executed, further cause the computer system to determine the fault of the component or the sensor by:
determining a first fault set including one or more faults indicated by one or more residuals of the data-driven model;
determining a second fault set including one or more faults indicated by one or more residuals of the physics-based model; and
determining the fault of the component or the sensor by identifying the fault is consistent with the first fault set and the second fault set.

16. The computer system of claim 14, wherein the instructions, when executed, further cause the computer system to:
create a first virtual sensor set associated with the first sensor subset;
determine a physics-based model set available to characterize a first physical process monitored by the first sensor subset based on the first virtual sensor set;
create a second virtual sensor set associated with the first sensor subset; and
select the physics-based model corresponding to the first sensor subset from the physics-based model set to characterize the first physical process based on the second virtual sensor set.

17. The computer system of claim 16, wherein the first virtual sensor set includes at least one model-driven virtual sensor and the second virtual sensor set includes at least one data-driven virtual sensor.

18. The computer system of claim 14, wherein the data-driven model is a multivariate state estimation technique (MSET) model.

19. The computer system of claim 14, wherein receiving the description includes receiving a piping and instrumentation diagram (P&ID) including components associated with the sensor set.

20. The computer system of claim 19, wherein the instructions, when executed, further cause the computer system to determine the fault association for each residual of each data-driven model by:
determining a component subset of the components associated with the sensor set that are involved in a first physical process monitored by the first sensor subset based on the P&ID; and
determining fault associations for residuals of the data-driven model corresponding to the first sensor subset corresponding to one or more component faults of the component subset based on the P&ID.
